(19) United States
(12) Patent Application Publication
(10) Pub. No.: US 2026/0104915 A1
(43) Pub. Date: Apr. 16, 2026

(54) GENERATING HARDWARE PROFILING INFORMATION FOR MULTI-THREADED ACCELERATORS

(71) Applicant: Intel Corporation, Santa Clara, CA (US)

(72) Inventors: Andrea Deidda, Leixlip (IE); Alfonso Tarazona Martinez, Celbridge (IE)

(73) Assignee: Intel Corporation, Santa Clara, CA (US)

(21) Appl. No.: 19/418,749

(22) Filed: Dec. 12, 2025

Related U.S. Application Data
(60) Provisional application No. 63/864,808, filed on Aug. 15, 2025.

(51) Int. Cl. G06F 9/48; G06F 9/50; G06F 11/30

(52) U.S. Cl. CPC G06F 9/4862; G06F 9/5016; G06F 11/3037; G06F 2209/508

(57) ABSTRACT

Processors executing machine learning workloads execute many data movement tasks in parallel. Collecting fine-grained performance information of the hardware execution of the data movement tasks while ensuring that the extraction of information does not affect the performance of workload execution is not trivial. To address this challenge, hardware profiling circuitry is integrated within the data movement engine to generate accurate task-level hardware profiling information, including timestamps, stall counts, a byte count, and cycle counts for individual data movement tasks. Upon executing a post action in the data movement engine for a data movement task, a log data entry for the data movement task can be written to memory at a memory address that corresponds to the data movement task and the context. Derived metrics, such as effective bandwidth, can be computed based on log data entries, facilitating diagnostics and system-level tuning.

### PRIORITY APPLICATION

This patent application claims priority to and/or receives benefit from U.S. Provisional Application No. 63/864,808, filed on 15 Aug. 2025, titled “GENERATING HARDWARE PROFILING INFORMATION FOR MULTI-THREADED ACCELERATORS.” The US Provisional Application is hereby incorporated by reference in its entirety.

### BACKGROUND

Deep neural networks (DNNs) are used extensively for a variety of machine learning (ML) and artificial intelligence (AI) applications ranging from computer vision to speech recognition and natural language processing due to their ability to achieve high accuracy. However, the high accuracy comes at the expense of significant computation cost. DNNs have extremely high computing demands as there can be a large number of operations as well as a large amount of data to read and write. Reading and writing data can be a bottleneck when executing AI applications.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates a computing system having a data movement engine with hardware profiling circuitry integrated therein, according to some embodiments of the disclosure.

FIG. 2 illustrates a linked list of data movement tasks, according to some embodiments of the disclosure.

FIG. 3 illustrates a lifecycle of a data movement task through a data movement engine, according to some embodiments of the disclosure.

FIG. 4 illustrates pipelined execution of multiple data movement tasks in a channel of a data movement engine, according to some embodiments of the disclosure.

FIG. 5 illustrates organizing profiling data for different contexts and different data movement tasks, according to some embodiments of the disclosure.

FIG. 6 illustrates a fixed size log data entry having hardware profiling information for a data movement task, according to some embodiments of the disclosure.

FIG. 7 illustrates different timestamps and a cycle count associated with a data movement task, according to some embodiments of the disclosure.

FIG. 8 depicts a table illustrating profiling data that can be recorded and stored in a log data entry, according to some embodiments of the disclosure.

FIG. 9 illustrates different metrics associated with a data movement task, according to some embodiments of the disclosure.

FIG. 10 depicts a table illustrating metrics which can be calculated based on the profiling data in a log data entry, according to some embodiments of the disclosure.

FIG. 11 illustrates a data movement engine having hardware profiling circuitry, according to some embodiments of the disclosure.

FIG. 12 illustrates generating a task identifier for a data movement task, according to some embodiments of the disclosure.

FIG. 13 illustrates generating a memory address for storing the log data for a data movement task and determining a task identifier for the data movement task, according to some embodiments of the disclosure.

FIG. 14 illustrates recording and draining profiling data for parallel or pipelined data movement tasks, according to some embodiments of the disclosure.

FIG. 15 illustrates profiling data for multiple data movement tasks, according to some embodiments of the disclosure.

FIG. 16 illustrates a system for analyzing the profiling data, according to some embodiments of the disclosure.

FIG. 17 is a flow diagram illustrating a method for collecting log data associated with data movement tasks, according to some embodiments of the disclosure.

FIG. 18 is a flow diagram illustrating a method for analyzing log data associated with data movement tasks, according to some embodiments of the disclosure.

FIG. 19 depicts a block diagram of an exemplary computing device, according to some embodiments of the disclosure.

### DETAILED DESCRIPTION

### Introduction

DNNs can be represented as a complex graph of interconnected actions of neural network operations. This graph of interconnected actions can be compiled and distilled into a sequence of actions to be performed by one or more hardware components, modules, or parts. Examples of hardware components can include a DNN accelerator, a neural processing unit (NPU), a data processing unit (DPU), a central processing unit (CPU), a graphics processing unit (GPU), a quantum processor, a machine learning processor, an AI processor, a neural network processor, an AI accelerator, an application-specific integrated circuit (ASIC), an analog signal processor, an analog computer, a microprocessor, a digital signal processor, a field programmable gate array (FPGA), a tensor processing unit (TPU), a neural network hardware accelerator, etc.

Many DNNs make use of complex data movement patterns, which are mapped as data movement tasks (or data movement jobs or data movement operations), to be performed by a data movement acceleration (DMA) hardware module that supports efficient movement of data from a memory to a memory of the hardware component carrying out the DNN operations. Implementations of DMA hardware modules to facilitate data movement are described in US Patent Publication No. 2023/0259467, which is hereby incorporated by reference in its entirety. Herein, the DMA hardware module may be referred to as a direct memory access engine, or data movement engine.

As with any application, performance does not come straight out of the box and can often require extraction of accurate profiling information about execution of workloads and tasks being carried out by hardware. This information is then used by software developers to tune the application and/or the compilation process to maximize efficient use of hardware and therefore application performance. The information and the act of extracting information about hardware execution of tasks is referred to as profiling.

Processors executing machine learning workloads execute many data movement tasks in parallel. In particular, the data movement patterns of an AI application having DNNs can be decomposed into a very high number of data movement tasks, each responsible for moving data between two memory locations. The data movement engine can process and perform data movement for multiple data movement tasks at a given point in time, both as parallel tasks as well as stage pipelined overlapping execution of tasks. Collecting fine-grained performance information of the hardware execution of the data movement tasks while ensuring that the extraction of information does not affect the performance of workload execution is not trivial.

Profiling data movement tasks can be done in isolation, where software triggers executing a profiling task to sample a timer before and after the data movement task execution to derive the amount of time needed to execute the task. Executing a profiling task to sample the timer in a real inference application is not practical, because the profiling task triggered from the software layer cannot gather information about many data movement tasks (e.g., hundreds of data movement tasks executing back-to-back and concurrently) without massively impacting the application performance.

Some approaches involve performance counters, which are integrated in the data movement engine, that perform counting activities for a multitude of events that happen during the application execution. Performance counter values can be then exposed to application developers. These approaches are effective in gathering information across the entire application execution without affecting performance but cannot provide dedicated sets of profiling information for individual data movement tasks.

To address this challenge, hardware profiling circuitry is integrated within the data movement engine to generate accurate task-level hardware profiling information by sniffing signals in the data movement engine to collect information for different data movement tasks. The information can include at least one or more of: timestamps, stall counts, byte count, and cycle counts.

In some embodiments, a multi-threaded processor with a data movement engine (DMA) can include hardware profiling (HWP) circuitry that is embedded and integrated alongside one or more link agents and one or more channel data path circuitry of the data movement engine. The multi-threaded processor can operate with multiple contexts (e.g., threads or processes), and the processor can have a local memory. The data movement engine can move data between the local memory of the processor and the further memory. Embedding or integrating HWP circuitry to collect hardware profiling data of the data movement engine can ensure that extraction and recording of profiling data can be done separately from the one or more link agents and one or more channel data path circuitry of the data movement engine and ensure that the performance and execution of the data movement tasks would not be impacted.

Herein, a link agent performs one or more processing (or pre-processing) actions of a data movement task. The one or more processing actions can include one or more of: receiving a pointer to a task descriptor, fetching a task descriptor of the data movement task, making sure the data movement task is ready for execution, waiting for a channel data path resource to be assigned (e.g., task scheduling), and allocating/dispatching the data movement task to a channel data path. Herein, a channel data path performs one or more data movement actions of a data movement task. The one or more data movement actions can include one or more of: a source request action, a response process action, a destination write action, and a post action. The one or more processing actions of the link agent and the one or more data movement actions of the channel data path make up the actions being performed in an end-to-end lifecycle of a data movement task.

In some embodiments, the HWP circuitry records log data associated with one or more data movement tasks based on one or more internal signals of the data movement engine. The HWP circuitry monitors or sniffs the one or more signals non-intrusively and orchestrates determining a memory address to write the log data and recording log data for one or more data movement tasks within the HWP circuitry at hardware speed without perturbing throughput or pipeline overlapping execution of actions in the data movement engine. This tight integration yields systematic, per-task observability under concurrency, which is an essential property for modern accelerator stacks where dozens of data movement tasks coexist across overlapped stages.

In some embodiments, the HWP circuitry provides a rich telemetry gathering layer by sniffing the one or more signals to produce timing information for one or more critical events happening across the lifecycle of a data movement task in a data movement engine. In some examples, the HWP circuitry timestamps lifecycle milestones, e.g., descriptor fetch, descriptor ready for execution, task dispatch/start, destination-write completion, and task finish. In some examples, the HWP circuitry accumulates request interface stall counts (read/write stalls), a byte count on data signals, and channel-cycle counts for destination writes. Because timestamps are captured against a global timer visible to the data movement engine, temporal relationships remain consistent across the one or more link agents and the one or more channel data path circuitry of the data movement engine, even in overlapped pipelines. This signal-driven approach delivers cycle-accurate visibility while avoiding intrusive probes, enabling robust decomposition of end-to-end latency into semantically meaningful sub-intervals that can be used by developers to optimize the application and the compilation process.

In some embodiments, the HWP circuitry monitors the execution of actions associated with a data movement task so that log data can be drained and written to memory upon completion of the actions. For example, upon detecting that a post action (e.g., a final action in the channel data path circuitry) is completed, the HWP circuitry triggers a commit of a compact log entry recorded in the HWP circuitry to memory. The channel data path circuitry can be used to write the log data to memory.

An application can control and configure the collection of log entries on specific external memory locations for various contexts while maintaining direct traceability of individual log entries to different data movement tasks for different contexts. The organization of log entries on memory is achieved through memory address calculation and task identifier determination in the HWP circuitry. By calculating the appropriate memory address to store a given log entry having profiling information of a data movement task of a context, the HWP circuitry can store the log entry in a memory location that is allocated to the data movement task of the context without conflicting with other log entries.

In some embodiments, the HWP circuitry determines a memory address for a data movement task for writing the log entry. For example, the HWP circuitry may determine a context identifier associated with the context associated with the data movement task. Based on the context identifier, the HWP circuitry can select the base memory address associated with the particular context. Moreover, the HWP circuitry can determine a task identifier associated with the data movement task. Preferably, each data movement task for a context has a unique task identifier. The HWP circuitry can determine the memory address based on the base address and the task identifier. Optionally, the HWP circuitry can determine the memory address based on the size of the log data/entry. In some embodiments, address computation in the HWP circuitry can be deterministic. The HWP circuitry can determine a memory address by mapping a context identifier to a per-context base address and combining it with a task identifier, optionally scaled by the fixed log entry/record size (e.g., 64 bytes). Advantageously, this “base+task-ID×record-size” memory address calculation scheme provides efficient memory indexing, preserves per-context locality, and eliminates runtime software bookkeeping. As a result, log entry/record writes are contention-resilient and avoids fragmentation across contexts. The log entry/record can include the task descriptor address, and thus the collection of log entries/records for various data movement tasks can still maintain direct traceability from a task descriptor to its corresponding log entry. Herein, a task descriptor is a structured data object stored in memory that corresponds to a specific data movement task. The task descriptor has information used by the data movement engine to execute a specific data movement task.

In some embodiments, the task identifier is preassigned by the context or the software application. In some embodiments, the task identifier is generated in hardware by the HWP circuitry. The HWP circuitry can decode the data movement task to extract the context and use a monotonic counter corresponding to the context to generate or allocate an appropriate task identifier. Because there can be multiple requests (e.g., from multiple link agents in the data movement engine) to generate task identifiers for a plurality of data movement tasks of a given context, the monotonic counter may be fronted by a round-robin arbiter to arbitrate between the requests to ensure fairness and scalability. The per-context partitioning removes inter-context interference, while the round-robin policy prevents head-of-line blocking and starvation when bursts of data movement tasks sharing the same context are requesting a task identifier. This design preserves strict monotonicity of identifiers for individual contexts.

Upon executing a post action in the data movement engine for a data movement task, a fixed-sized log data entry for the data movement task can be written to memory at a memory address that corresponds to the data movement task and the context.

The log data may include the task descriptor address, which may be the memory address of the task descriptor corresponding to the data movement task. As discussed previously, the task descriptor address can uniquely identify the data movement task.

The log data may include one or more timestamps. Examples of timestamps can include: a timestamp corresponding to the task descriptor is fetched, a timestamp corresponding to when the task is ready for execution or to be dispatched to the channel data path circuitry, a timestamp corresponding to when the task is dispatched to the channel data path circuitry, a timestamp when destination data write action for the task is completed, and a timestamp when all the actions for the data movement task are fully completed.

The log data may include one or more stall counts. Examples of stall counts can include a read stall count counting a number of times the task was stalled waiting to read data, and a write stall count counting of times the task was stalled waiting to write data.

The log data may include one or more performance counts. Examples of performance counts can include channel cycle count counting a number of clock cycles taken to complete the write actions, and a byte count counting a total number of bytes written during the data movement task.

The log data may include one or more of a link agent identifier identifying the link agent that processed the data movement task, and a channel identifier identifying the channel data path circuitry that processed the job.

In some embodiments, the HWP circuitry maintains parallel record scoreboards to accommodate tracking profiling data for pipelined execution of data movement tasks by a channel data path circuitry. The parallel records maintained in the HWP circuitry can be aligned to the pipeline depth of the channel data path circuitry. Specifically, the HWP circuitry can maintain a plurality of per-task storage records, at least equal to the pipeline depth. The HWP circuitry can select the appropriate record to record a piece of profiling information by determining the task identifier associated with the piece of profiling information and writing the piece of profiling information to the selected record. Upon the post action completion, the HWP logger can determine the task identifier associated with the post action completion to select the matching record, drain the aggregated profiling information to the channel data path circuitry, and trigger a single atomic write of the fixed-size log entry/record at the computed address.

Derived metrics, such as effective bandwidth, can be computed based on log data entries, facilitating diagnostics and system-level tuning. Post-processing software can be executed to retrieve log entries/records from memory and compute metrics, including latency intervals such as a duration between descriptor fetch to task being ready, a duration between task being ready and dispatch to channel, a duration between a channel execution start time to a destination write action completion, a duration between a destination write action completion to post action completion, a duration between a channel execution start time to a channel execution finish time, duration between descriptor fetch to a channel execution finish time, and a ratio of byte count to channel cycle count (e.g., a normalized task-level data movement bandwidth independent of task size). The metrics based on microarchitectural events can be actionable for developers to optimize compilers, runtime schedulers, and buffer-management policies.

From a systems standpoint, the HWP circuitry advance hardware-assisted profiling for accelerators in several ways. First, profiling becomes effectively zero-overhead: observation is concurrent with execution and gated by hardware events and signals rather than software traps. Second, granularity is preserved under concurrency, where the per-task records maintain accurate profiling telemetry information across overlapped stages in the channel data path circuitry, enabling attribution of waits and stalls to specific tasks and contexts. Third, fairness and scalability in task identifier assignment and the fixed schema and deterministic addressing support ensure that memory addresses are appropriately allocated for storing fine-grained per-task log entries for various contexts. Individually and collectively, these features can enable developers to effectively investigate and optimize data movement task scheduling, barrier placement, and throughput optimization in multi-threaded accelerators.

### Data Movement Engine With Hardware Profiling

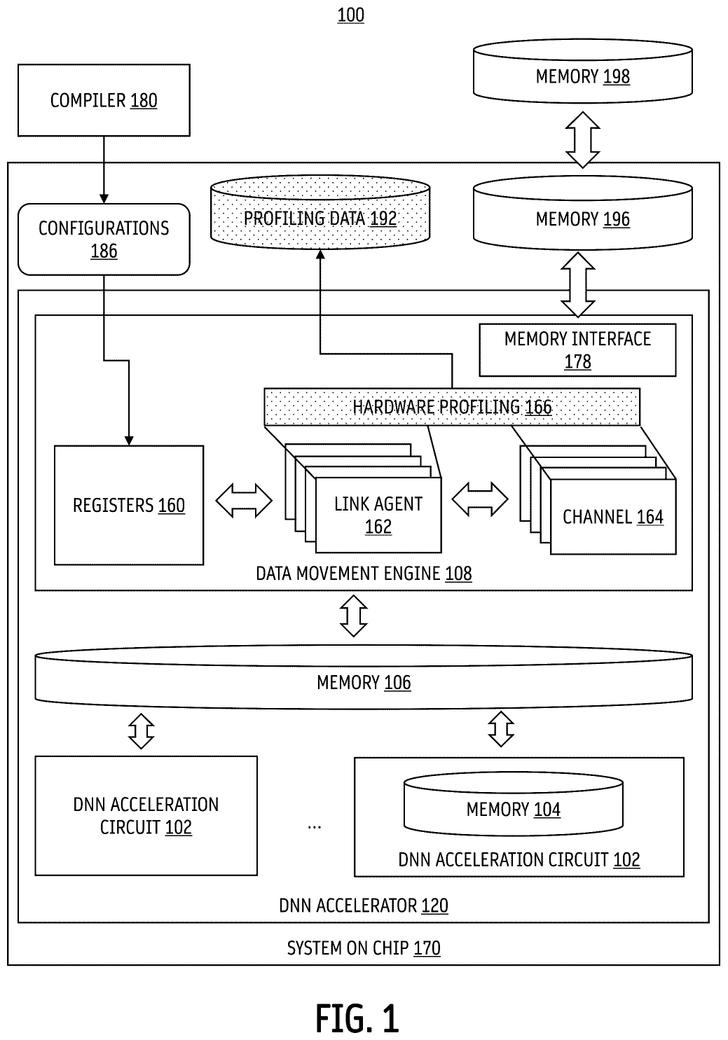

FIG. 1 illustrates computing system 100 having data movement engine 108 with hardware profiling 166 (hardware profiling circuitry) integrated therein, according to some embodiments of the disclosure. Computing system 100 may include system on-chip (SoC) 170. SoC 170 can be an integrated circuit that integrates various components or circuits of a computer or electronic system, such as different types of processors different types of hardware accelerators, memory, input/output ports, and often onto a single chip or package. SoC 170 may include DNN accelerator 120. In some cases, SoC 170 may include one or more instances of DNN accelerator 120. SoC 170 may include other processing components such as a CPU, a GPU, a digital signal processor (DSP), an image signal process (ISP), etc.

DNN accelerator 120 may be a hardware accelerator designed to accelerate execution of neural network operations or other computing operations. DNN accelerator 120 may include one or more compute engines that are optimized to perform neural network operations commonly found in neural networks, such as convolutions, matrix multiplications, applying activation functions, reshaping of tensors, etc. An exemplary compute engine to accelerate neural network operations is shown in FIG. 1 as DNN acceleration circuit 102. Examples of the one or more compute engines in DNN accelerator 120 can include a digital signal processor, a systolic array, multiply and accumulate array, analog compute-in-memory array, digital compute-in-memory array, an ASIC, a vector data processing circuit, a scalar data processing circuit, tensor processing circuit, reconfigurable fabric such as a FPGA, etc.

Compiler 180, e.g., executing on a computing system, may receive a high-level neural network model definition and generate low-level machine-readable instructions, such as configurations 186, based on the definition. In some embodiments, compiler 180 ingests a graph of layers, operations, and tensors, produces an internal intermediate representation. Compiler 180 can apply optimizations such as fusion, scheduling, precision/layout propagation, and memory planning to match data-processing pipeline of DNN accelerator 120. From the optimized processing graph, compiler 180 can partition the operations in the graph into workloads for DNN accelerator 120 and perform various optimizations such as tiling and data movement optimizations. Compiler 180 can convert the workloads into configurations 186 (e.g., referred to as configuration descriptors in some contexts), which are structured command blocks that configure blocks in DNN accelerator 120 and/or blocks in DNN acceleration circuit 102 to execute neural network operations. One example of configurations 186 may include or specify one or more of: operation type, control flags, kernel and/or tensor metadata (e.g., dimensions, strides, dilation, padding, size, data formats, sparsity bitmaps, etc.), memory access/mapping information (e.g., source memory addresses, destination memory addresses, data size), post-processing parameters (e.g., bias addition, activation function information, quantization, etc.), etc. In some embodiments, configurations 186 may include data movement tasks (e.g., encoded as task descriptors, task configurations, or data movement task configurations) that support data movement for executing one or more neural network operations. Configurations 186 may be loaded onto DNN accelerator 120 to configure DNN accelerator 120 and components therein to perform one or more neural network operations and data movement tasks.

SoC 170 can leverage a multi-level or hierarchical memory system having one or more of: large off-chip memory (e.g., shown as memory 198 that is external to SoC 170), limited on-chip memory (e.g., shown as memory 196 as part of SoC 170), intermediate on-chip memory (e.g., shown as memory 106 as part of DNN accelerator 120), and local memory such as register files or memory cells within a compute engine for immediate data access (e.g., shown as memory 104). Data can be moved between different memories in the memory system when DNN accelerator 120 is executing one or more neural network operations. Data can flow from off-chip memory (e.g., memory 198) into the on-chip memory (e.g., memory 196) of SoC 170 for staging, then into intermediate buffers (e.g., memory 106) within DNN accelerator 120 to feed the local memory of a high-throughput compute engine (e.g., memory 104 of DNN acceleration circuit 102). Operands from intermediate buffers within DNN accelerator 120 can be loaded into the local memory of the compute engine (e.g., memory 104 of DNN accelerator circuit 102) for cycle-level execution. After computation by the compute engine, intermediate results can be written to the local memory of the compute engine and reused for one or more next cycles if appropriate. Final results can be written to the local memory of the compute engine, and the final results can propagate back through the hierarchy, e.g., first to intermediate buffers (e.g., memory 106) for optional reuse within DNN accelerator 120, then to the on-chip memory (e.g., memory 196) of SoC 170, and finally to off-chip memory (e.g., memory 198) if appropriate.

DNN acceleration circuit 102 may accelerate operations in neural network model execution. DNN acceleration circuit 102 may receive operands such as input activations and optionally weights, transform the input activations, and generate output activations. DNN acceleration circuit 102 may apply weights to input activations to transform input activations and generate output activations.

Data movement in computing system 100 can present a significant bottleneck when executing operations for DNNs, because transferring data between different levels of memory hierarchy as depicted in FIG. 1 often incurs latency and resource overhead. Without efficient scheduling and profiling, redundant data transfers and insufficient bandwidth can slow down computation, limiting overall system throughput and performance. As a result, optimizing data movement, such as scheduling and planning of data movement tasks, can be essential for accelerating DNN workloads and achieving efficient execution. Efficient scheduling and tiling strategies are often employed to reduce data movement across these memory levels within the memory system. However, optimization strategies demand fine-grained information about the performance of data movement engine 108, which can be difficult to obtain without impacting the performance of data movement engine 108.

Data movement engine 108 may include memory interface 178 that connects the memory outside DNN acceleration circuit 102 (e.g., memory 196) and memory inside DNN acceleration circuit 102 (e.g., memory 106 of DNN acceleration circuit 102), to facilitate data transmission and transfer.

Data movement engine 108 may include registers 160, which includes at least one or more of configuration registers (to store one or more task descriptors that configure data movement engine 108 to perform one or more data movement tasks) and one or more status registers (to store status or state information of data movement engine 108).

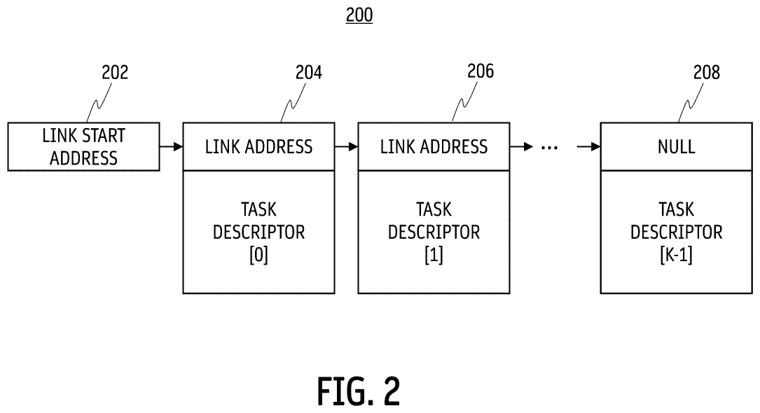

Data movement engine 108 may include one or more instances of link agent 162. Link agent 162 is responsible for processing a data movement task linked list (which is illustrated in FIG. 2). Data movement engine 108 can include a plurality of instances of link agent 162. Link agent 162 acts as the interface for managing data transfer tasks between two memories in a DNN accelerator. Link agent 162 can fetch task descriptors from memory, which may include attributes like data block size, source and destination addresses, and other parameters. After retrieving the task descriptors, link agent 162 initiates execution by passing them to an instance of channel 164 to execute the data movement actions. Link agent 162 ensures proper sequencing and coordination (e.g., dispatching) of data movement tasks. Link agent 162 pre-processes or prepares the data movement task before an instance of channel 164 performs the data movement actions.

Data movement engine 108 may include one or more instances of channel 164. Channel 164 can include one or more dedicated circuits for processing and executing data movement actions to move data across memory interface 178. Each data channel can operate independently, allowing for parallel execution of multiple data movement operations. Channel 164 can in a staged pipelined manner, enabling parallel processing of multiple data movement tasks to minimize latency. Channel 164 can move data between source and destination memory regions, e.g., without processor intervention. Channel 164 can include a pipelined architecture with multiple stages. Channel 164 can perform data movement actions based on a task descriptor provided by link agent 162. Link agent 162 can include control logic for synchronization, error detection, and flow management, enabling concurrent operation with other channels to achieve parallel data movement.

In some embodiments, the number of instances of link agent 162 is the same as the number of instances of channel 164. In some embodiments, the number of instances of link agent 162 is greater than the number of instances of channel 164. In some embodiments, the number of instances of link agent 162 is less than the number of instances of channel 164. The one or more instances of channel 164 is shared between (e.g., is a shared resource for) the one or more instances of link agent 162.

Data movement engine 108 includes hardware profiling 166 (referred to herein as HWP circuitry or HWP circuit). Hardware profiling 166 is an integrated or embedded hardware circuit to independently capture detailed, task-level execution profiling information for data movement tasks within a multi-threaded computing environment. In the context of computing system 100, the multi-threaded computing environment can encompass parallel processing at different levels, and hardware profiling 166 is able to manage tracking profiling data even in the presence of parallel processing and concurrency. Hardware profiling 166 can address one or more levels of parallelism the multi-threaded computing environment. At the processor level, hardware profiling 166 supports profiling across multiple independent contexts, enabling concurrent applications to be tracked separately. Within data movement engine 108, hardware profiling 166 enables parallel profiling of multiple data movement tasks that may be processed simultaneously by different instances of link agent 162. Hardware profiling 166 further supports pipelined parallelism inside an instance of channel 164, capturing profiling data for several data movement tasks as they progress through different pipeline stages concurrently. Hardware profiling 166 implements comprehensive approach to ensure accurate, task-level profiling across all dimensions of parallel execution, from multi-context processors to multi-threaded, pipelined hardware of data movement engine 108.

For each data movement task going through an instance of link agent 162 and an instance of channel 164, hardware profiling 166 records critical event timestamps and performance counters, such as including task initiation, completion, stall counts, and bandwidth, without impacting application performance. This profiling information is systematically organized in memory, shown as profiling data 192, as an array of log entries, each uniquely indexed to its corresponding task via either software-assigned or hardware-generated identifiers. By enabling fine-grained, parallel tracking of multiple concurrent tasks, profiling data 192 collected by hardware profiling 166 provides developers and hardware designers with actionable insights for performance tuning, debugging, and iterative hardware/software optimization, all while maintaining direct traceability between profiling data and the underlying task descriptors.

Hardware profiling 166 may be provided to, coupled to, embedded in, or integrated with one or more instances of link agent 162 and one or more instances of channel 164 to perform end-to-end monitoring of data movement tasks as they are processed in data movement engine 108.

### Linked List of Data Movement Tasks

FIG. 2 illustrates linked list 200 of data movement tasks, according to some embodiments of the disclosure. Linked list 200 has a task linked list structure used for organizing and executing multiple data movement tasks within a hardware accelerator (e.g., DNN acceleration circuit 102 of FIG. 1). The sequence of linked list 200 begins with head item 202 having a link start address, which points to item 204 of linked list 200. Each item in linked list 200 includes a link address field and an associated task descriptor field. The link address field serves as a pointer to the next item (e.g., the next task descriptor) in the sequence of linked list 200, enabling efficient traversal and execution of tasks in order. The link address of item 204 points to item 206. The link address of item 206 points to a following item of linked list 200. Final item 208 in linked list 200 is terminated with a NULL link address, indicating the end of the task sequence of linked list 200.

The task descriptor encapsulates all necessary information for the data movement engine to perform a specific data movement task, such as source and destination addresses, transfer size, and control parameters. In particular, the task descriptor includes configuration information to configure the data movement engine to carry out the data movement task. In some embodiments, a task descriptor encoding or describing a data movement task can include one or more fields or data, such as source and destination memory addresses (indicating where data should be read from and written to), transfer size (the amount of data to be moved), context identifier (specifies the execution context or application domain for the task), task identifier (uniquely identifies the task within a context, optionally assigned by software such as the compiler), control flags and options (e.g., settings for profiling, chaining, or special handling), and a pointer to the next task descriptor (e.g., to link linking multiple tasks into a linked list for sequential or pipelined execution).

The architecture or structure of linked list 200 allows for flexible and scalable management of data movement tasks, supporting both sequential and parallel execution models. By chaining task descriptors in this manner, the data movement engine can process a series of data movement tasks specified in linked lists such as linked list 200 with minimal software intervention, facilitating high-throughput and low-latency execution in complex, multi-threaded environments.

### Lifecycle of a Data Movement Task Through a Data Movement Engine

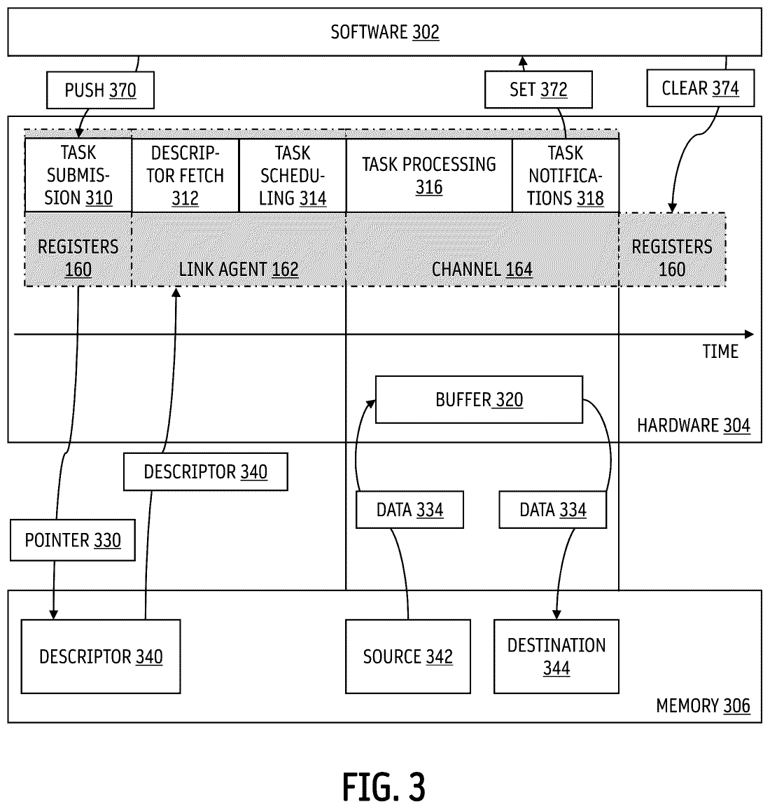

FIG. 3 illustrates a lifecycle of a data movement task through a data movement engine, according to some embodiments of the disclosure. The computing environment includes software layer 302 (e.g., representing the application), hardware layer 304 (e.g., representing a data movement engine of a DNN accelerator), and memory layer 306 (e.g., encompassing different levels of memory or storage of the computing environment).

The lifecycle can begin in software layer 302, where a data movement task is initiated via push operation 370 and submitted to registers 160 as part of task submission phase 310. Push operation 370 submits pointer 330 to a task descriptor encapsulating information for executing the data movement task. Upon completion, task submission phase 310 transitions to descriptor fetch phase 312

During descriptor fetch phase 312, link agent 162 uses pointer 330 to the task descriptor from registers 160 to fetch task descriptor 340 from memory layer 306. Upon completion, descriptor fetch phase 312 transitions to task scheduling phase 314

During task scheduling phase 314, link agent 162 prepares the data movement task for execution and dispatches the data movement task to channel 164. Upon completion, task scheduling phase 314 transitions to task processing phase 316

During task processing phase 316, channel 164 uses buffer 320 to move data 3 34 moving data 334 from source 342 to destination 344. Upon completion, task processing phase 316 transitions to task notifications phase 318.

During task notifications phase 318, channel 164 communicates status updates back to software layer 302, e.g., issuing set command 372 to indicate completion of data movement.

Software layer 302 may issue clear command 374 to update registers 160.

### Pipelined Parallel Execution of Data Movement Tasks Within a Channel

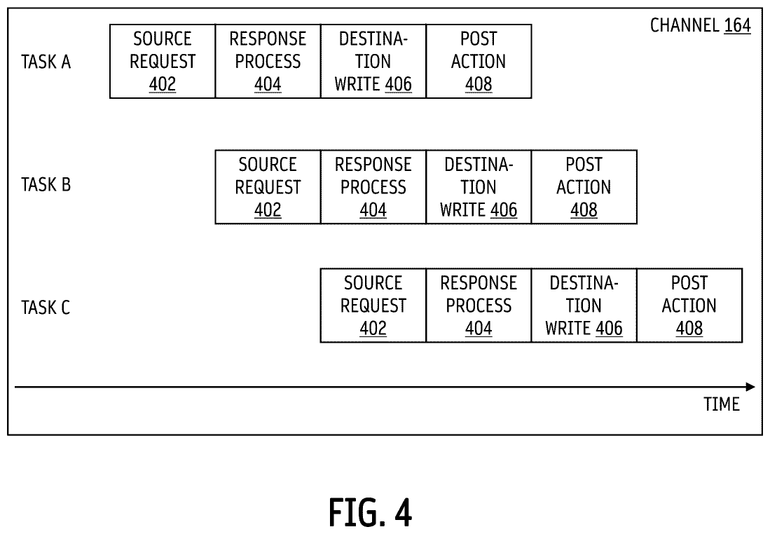

FIG. 4 illustrates pipelined execution of multiple data movement tasks in channel 164 of a data movement engine, according to some embodiments of the disclosure. As seen in FIG. 4, multiple data movement tasks can be executed in parallel, in accordance with various embodiments. The data transfer tasks A, B, and C may be executed or handled by channel 164 concurrently.

A data movement task, whose lifecycle was illustrated in FIG. 3, can have one or more stages of operation in channel 164. The stages are also referred to as data movement actions being executed or carried out in channel 164. The one or more stages can include, in this sequence, source request action 402, response process action 404, destination write action 406, and post action 408. Source request action 402 can include issuing read requests to the source memory to fetch the data block. Response process action 404 can include receiving and storing the data block fetched from the source memory in a buffer. Destination write action 406 can include writing the data stored in the buffer to the destination memory. Post action 408 can include confirming completion of the data movement task (e.g., via a notification or interrupt). Each action is performed by dedicated circuitry or block in channel 164. The blocks are arranged in a pipeline, with one block following another, to enable pipelined execution of multiple data transfer tasks.

The four staged data movement actions in the pipeline, e.g., source request action 402, response process action 404, destination write action 406, and post action 408, can yield a pipelining depth of four, and can support concurrent processing of four parallel data movement tasks, enabling high-throughput and efficient resource utilization of channel 164.

Once the block to execute source request action 402 has completed the action for task A, the block to execute response process action 404 can be triggered to complete the next action for task A. At the same time, the block to execute source request action 402 is free to complete the action for task B while the block to execute response process action 404 is completing the action for task A.

This pipelined architecture in channel 164 allows new data movement tasks to enter the processing flow before previous tasks have completed, with each stage operating independently on separate tasks. As shown, while task A advances post action 408, task B may be in destination write action 406, and task C can be in response process action 404, illustrating concurrency and parallelism across the pipeline.

Memory Tiles for Storing Indexed Log Data Records for Different Contexts

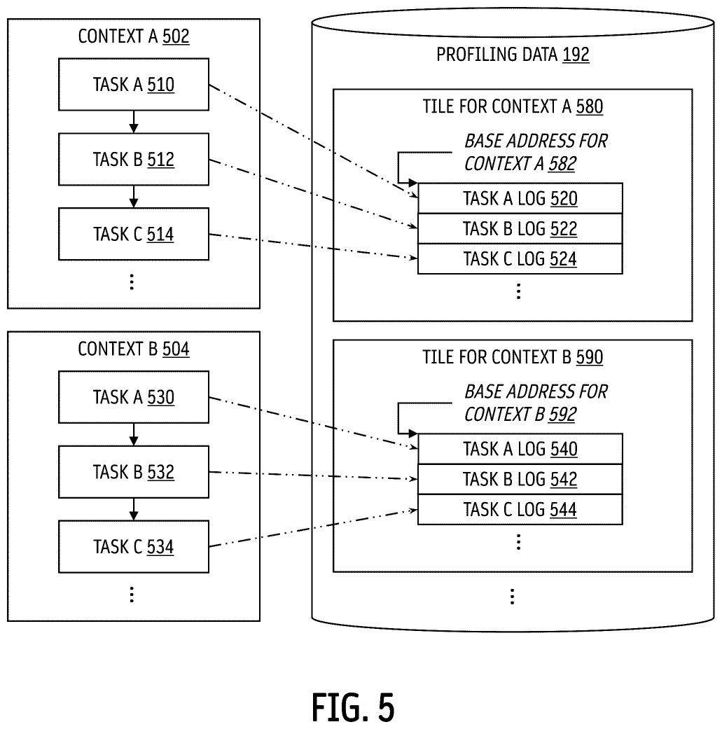

FIG. 5 illustrates organizing profiling data 192 for different contexts and different data movement tasks, according to some embodiments of the disclosure. The solution for hardware profiling sets up a buffer in memory where the log records/entries for various data movement tasks and one or more contexts can be stored in profiling data 192 in a conflict-free and scalable manner. For each data movement task, a compact log record/entry (e.g., having a size of 64 bytes) can be written to memory at a designated memory location and stored in profiling data 192. For a given context, the buffer in memory to store the log records/entries can be logically seen as an array of log items indexed by a task identifier.

More specifically, FIG. 5 illustrates the arrangement of profiling log items in memory for multiple execution contexts and their respective tasks. An execution context, such as context A 502 and context B 504, can include a sequence of data movement tasks. Context A 502 can include task A 510, task B 512, task C 514. Context B 504 can include task A 530, task B 532, task C 534 for context B. For each context, profiling data 192 is organized into a dedicated memory tile, e.g., tile for context A 580 and tile for context B 590. A memory tile for a context can begin at a unique base address (e.g., base address for context A 582, base address for context B 592) that is assigned or allocated to the context.

Within a tile, individual log items/records/entries (e.g., 64-byte chunks) are allocated for individual data movement tasks being executed in the corresponding context. For example, tile for context A 580 can include task A log 520, task B log 522, and task C log 524, and tile for context B 590 can include task A log 540, task B log 542, and task C log 544. A log item/record/entry can store detailed profiling information for its associated data movement task, such as execution timestamps, performance counters, and hardware event metrics, enabling fine-grained analysis of task behavior and system performance. The log item/record/entry for a data movement task can also store the memory address of the task descriptor for the data movement task to maintain direct traceability between tasks and their profiling data.

In some embodiments, software or the application can specify the base address for a particular context (e.g., associate a context identifier to a specific base address for the memory tile, and store the association in registers accessible by the HWP circuitry). The configurability of the base address can allow multiple applications executing concurrently (identified by a context identifier) to profile, collect and generate independent memory tiles having respective log records/entries for the context. In some embodiments, the HWP circuitry may assign a suitable base address for a particular context. In some embodiments, the base address for a particular context may be predefined or pre-allocated.

This memory arrangement ensures supporting concurrent profiling across multiple contexts without data collision or ambiguity. By indexing log items according to both context and task, the system facilitates efficient retrieval, post-processing, and visualization of profiling information, which is beneficial for debugging, performance tuning, and iterative hardware/software optimization. The architecture is scalable, allowing additional contexts and tasks to be accommodated by allocating further tiles and log items within the profiling data memory structure.

Log Record Format

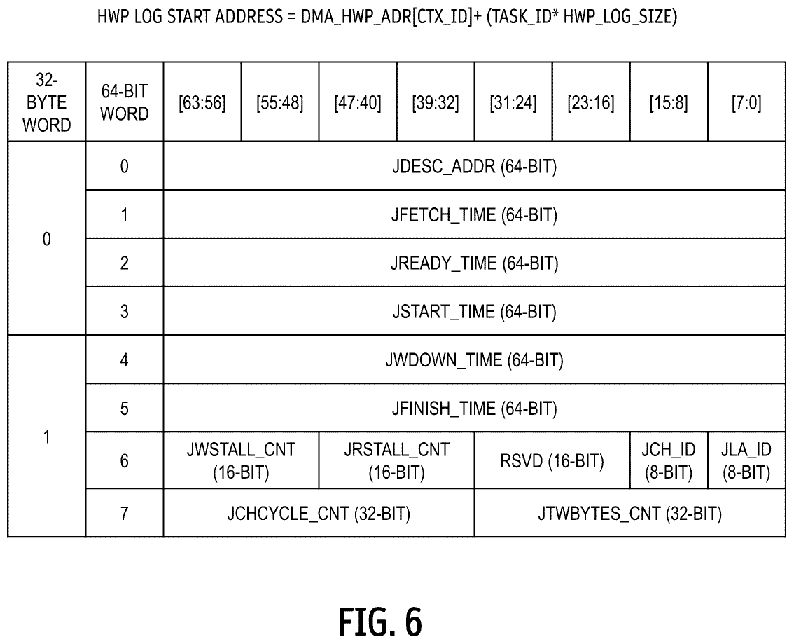

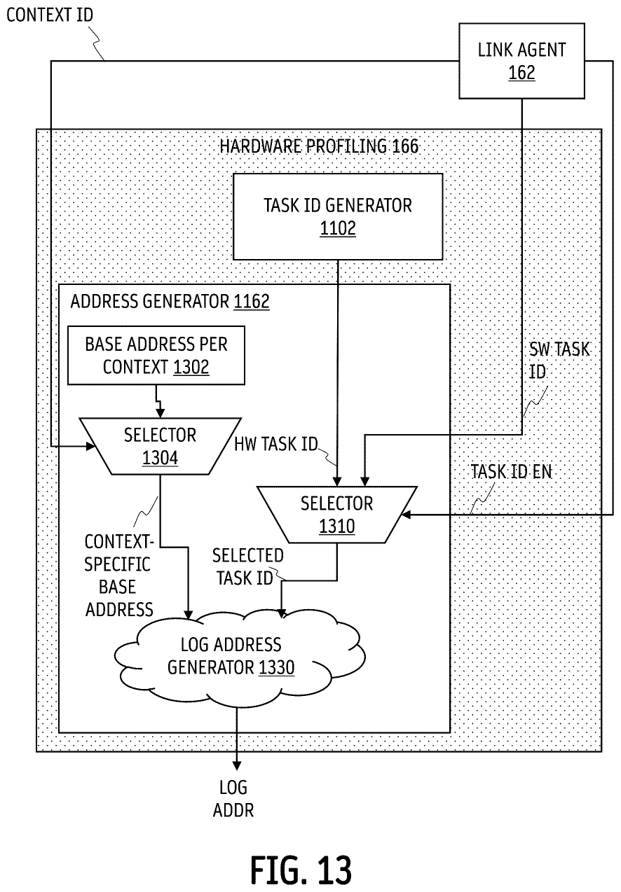

FIG. 6 illustrates a fixed size log data entry having hardware profiling information for a data movement task, according to some embodiments of the disclosure. The data structure of a log data entry can occupies 64 bytes in memory and include detailed execution profiling information for a data movement task of a context As seen in FIG. 5, the log item is indexed or identified by its corresponding context identifier and task identifier, with its start memory address computed as DMA_HWP_ADR[CTX_ID]+(TASK_ID×HWP_LOG_SIZE). This means that each log entry, which records profiling information for a specific data movement task, is uniquely identified by two pieces of information: the context identifier (CTX_ID) and the task identifier (TASK_ID). To determine where in memory this log entry should be stored, the system calculates the starting memory address by taking the base address assigned to the context (DMA_HWP_ADR[CTX_ID]) and adding an offset (TASK_ID×HWP_LOG_SIZE). This offset is calculated by multiplying the task's identifier (TASK_ID) by the fixed size of each log entry (HWP_LOG_SIZE). In other words, the formula ensures that each task's log entry is placed in the correct/allocated location within the memory tile dedicated to its context, preventing overlap and making retrieval efficient. The memory address computation is illustrated in greater detail in FIG. 13. The memory address computation ensuring direct traceability to both the execution context and the specific task.

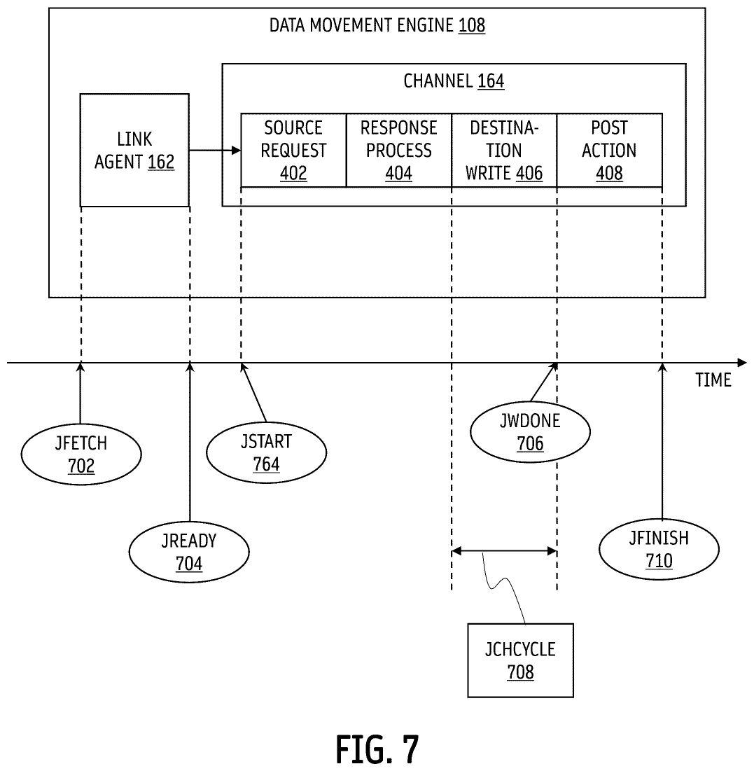

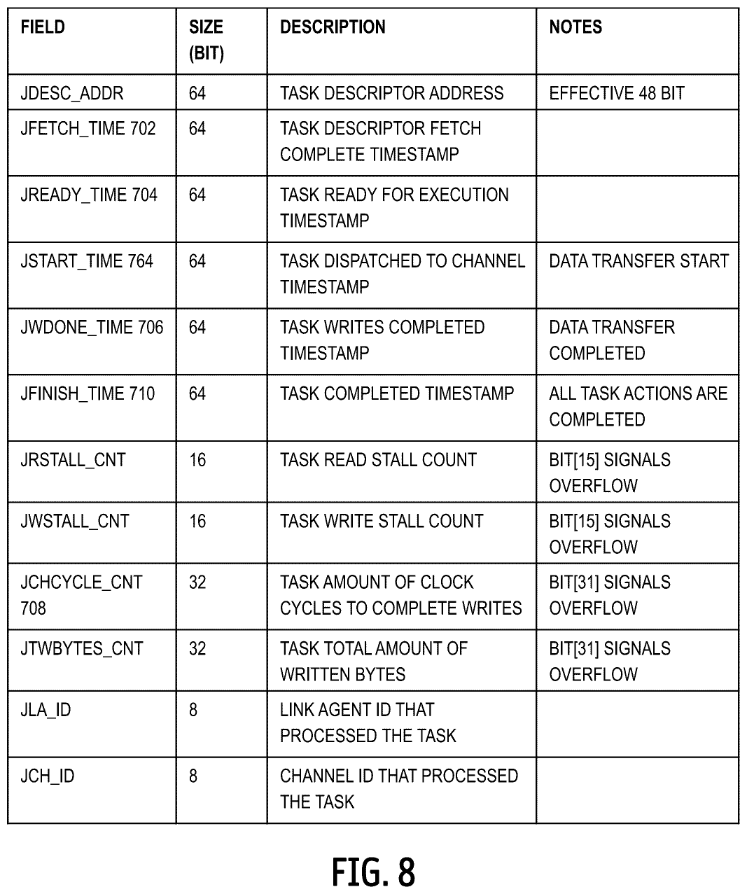

A log record/entry can include eight 64-bit words, with fields mapped to specific bit ranges for efficient storage and retrieval. The fields are further illustrated in greater detail in FIGS. 7-8. The first six words (words 0-5) may capture task metadata and timing information. Task metadata includes JDESC_ADDR (64-bit) to record the job descriptor address. Timing information can include JFETCH_TIME, JREADY_TIME, JSTART_TIME, JWDONE_TIME, and JFINISH_TIME (each 64-bit) log timestamps for key events in the task's lifecycle, such as fetch completion, task ready for dispatch, dispatch, write completion, and overall finish, respectively. Word 6 includes performance counters and identifiers. Performance counters can include JWSTALL_CNT and JRSTALL_CNT (16-bit each) to track write and read stall events respectively. RSVD (16-bit) is reserved. Identifiers can include JCH_ID and JLA_ID (8-bit each) to identify the channel and link agent, respectively, responsible for processing the data movement task. Word 7 can include additional metrics. Additional metrics can include JCHCYCLE_CNT (32-bit) to record the number of clock cycles for write completion, and JTWBYTES_CNT (32-bit) to log the total number of bytes written. This compact, standardized format seen in FIG. 6 enables rapid post-processing and analysis of task-level profiling data, supporting robust performance tuning and debugging in multi-threaded, multi-context hardware environments.

### Raw Profiling Information

FIG. 7 illustrates different timestamps and a cycle count associated with a data movement task, according to some embodiments of the disclosure. In particular, FIG. 7 illustrates the sampling of performance data, including timestamps and cycle count, during the processing of a data movement task within data movement engine 108. As discussed previously with FIGS. 3-4, processing of a data movement task begins with link agent 162, which receives a task submission and prepares the task for dispatch with channel 164. Channel 164 comprises four pipelined stages or data movement actions: source request action 402, response process action 404, destination write action 406, and post action 408. As the data movement task progresses through these stages or the actions are completed in the pipeline in channel 164, key events are timestamped to enable precise profiling.

The HWP circuitry can record JFETCH 702, a timestamp representing when the task descriptor is fetched by link agent 162. The HWP circuitry can record JREADY 704, a timestamp representing when link agent 162 has the task ready for execution by channel 164. The HWP circuitry can record JSTART 764, a timestamp representing when the task is dispatched to channel 164. The HWP circuitry can record JWDONE 706, a timestamp representing when destination write action 406 is completed. The HWP circuitry can record JFINISH 710, a timestamp when all actions for the task are finalized, or when post action 408 is completed. These timestamps are captured at notable transition points during the end-to-end processing of a data movement task, providing a detailed temporal map of the task's lifecycle.

In addition to event timestamps, the HWP circuitry can record JCHCYCLE 708, which represents the number of clock cycles consumed between the initiation and completion of destination write action 406. This cycle count is useful for evaluating the efficiency and throughput of the data movement engine, as the number of cycles can be used to calculate bandwidth and identification of performance bottlenecks. Capturing cycle counts, rather than relying solely on timestamps, is particularly helpful for profiling high frequency events because cycles provide fine-grained temporal resolution that matches the hardware's native operating speed. While timestamps may be limited by their sampling rate or clock granularity, cycle counts can reflect even the smallest intervals between hardware actions, allowing developers to precisely measure the duration of rapid operations (e.g., destination write action 406) that might otherwise be missed or blurred in timestamp-based logging. This enables accurate analysis of performance bottlenecks and optimizations in environments where tasks are executed at very high speeds or frequencies, and subtle variations in execution time are critical for tuning system efficiency.

FIG. 8 depicts a table illustrating profiling data that can be recorded and stored in a log data entry, according to some embodiments of the disclosure. The field, size, description, and notes information in the table correspond to the data fields illustrated in a representative log entry/record format of FIG. 6.

JDESC_ADDR (64 bits) records the effective address of the task descriptor.

Timestamp fields, such as JFETCH_TIME, JREADY_TIME, JSTART_TIME, JWDONE_TIME, and JFINISH_TIME (each 64 bits), capture the precise moments of descriptor fetch completion, readiness for execution, dispatch to the channel (marking data transfer start), write completion (marking data transfer completion), and overall task completion, respectively.

Performance counters, such as JRSTALL_CNT and JWSTALL_CNT (16 bits each), record the number of read and write stall events encountered during task execution. Overflow can be indicated/signaled by a bit, e.g., BIT[15]. JCHCYCLE_CNT (32 bits) logs the total number of clock cycles to complete write operations, and JTWBYTES_CNT (32 bits) captures the total number of bytes written. Overflow can be indicated by a bit, e.g., BIT[31].

Overflow bits are included in one or more profiling data fields to signal when the value stored in a counter exceeds the maximum value that can be represented by the allocated bit width. For example, a 16-bit stall counter (such as JRSTALL_CNT or JWSTALL_CNT) can represent values from 0 to 32,767; if the actual count goes beyond this range, the highest bit (BIT[15]) is set to indicate overflow. Similarly, for 32-bit counters like JCHCYCLE_CNT and JTWBYTES_CNT, BIT[31] signals overflow if the count exceeds 2,147,483,647. Including overflow bits can be useful in hardware profiling because it allows the system or software analyzing the logs to detect when a counter has wrapped around, ensuring that performance data is interpreted correctly and that unusually high activity or long-running tasks are not misrepresented due to counter limitations. This mechanism helps maintain the integrity and reliability of profiling data, especially in high-throughput or long-duration scenarios.

JLA_ID (8 bits) and JCH_ID (8 bits) can uniquely identify the link agent and channel responsible for processing the task, respectively.

### Metrics Derivable From Raw Profiling Data

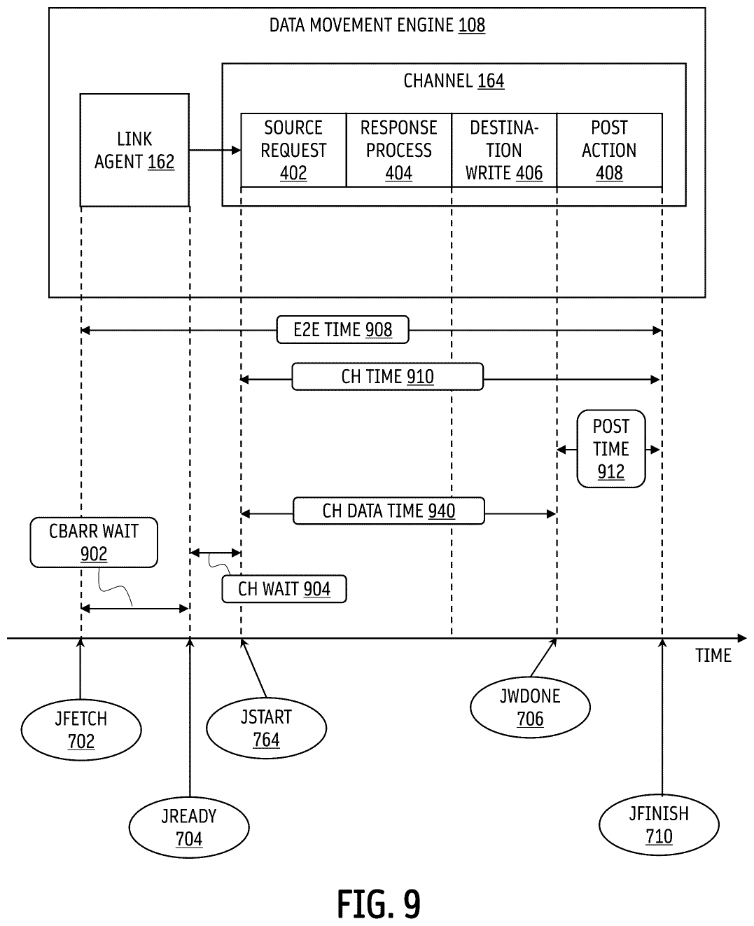

FIG. 9 illustrates different metrics associated with a data movement task, according to some embodiments of the disclosure. Leveraging the profiling data collected by the HWP circuitry (e.g., as illustrated in FIGS. 6-8), one or more metrics can be derived from the profiling data.

E2E TIME 908 (end-to-end time) metric represents the end-to-end duration of processing and executing a data movement task, measured from the initial fetch timestamp (JFETCH 702) to the final completion timestamp (JFINISH 710), providing a comprehensive view of the total latency experienced by the data movement task.

CH DATA TIME 940 (data movement duration) quantifies the time spent to read and write data in channel 164, or the duration of time to execute the three actions in channel 164 (e.g., source request action 402, response process action 404, and destination write action 406). CH DATA TIME 940 can be measured from the start of data processing (JSTART 764) to the completion of data writes (JWDONE 706). This metric can isolating the core data transfer duration and identifying bottlenecks within the channel pipeline associated with moving data.

CH TIME 910 (channel duration) quantifies the time spent to complete all actions in channel 164, or the duration of time to execute the four actions in channel 164 (e.g., source request action 402, response process action 404, destination write action 406, and post action 408). CH TIME 910 can be measured from the start of data processing (JSTART 764) to the completion of post actions (JFINISH 710). CH TIME 910 can measure the amount of time the data movement task is utilizing channel 164, supporting granular analysis of throughput and pipeline utilization of channel 164.

POST TIME 912 (post action duration) measures the time to perform for post-processing actions following data transfer completion (e.g., represented by post action 408), spanning from JWDONE 706 to JFINISH 710. POST TIME 912 is useful for evaluating the efficiency of finalization and notification mechanisms.

CBARR WAIT 902 (channel barrier wait) can represent the amount of time a data movement task spends waiting for a synchronization barrier within the channel pipeline. In hardware accelerators, barriers are used to ensure that certain operations or data dependencies are resolved before a task can proceed. CBARR WAIT 902 can be measured from the moment the task descriptor is fetched (JFETCH 702) until the channel is ready to begin processing the task (JREADY 704). This metric captures delays caused by resource contention, dependency resolution, or pipeline synchronization, and is critical for identifying bottlenecks related to task scheduling and inter-task dependencies.

CH WAIT 904 (channel resource wait) can quantify the time a data movement task spends waiting for the channel to become available after it is ready for execution but before actual data movement begins. Specifically, CH WAIT 904 can be measured from the point when the task is ready (JREADY 704) to when the task is dispatched to the channel for processing (JSTART 764). This wait time can be caused by channel occupancy, prioritization of other tasks, or hardware arbitration mechanisms. By analyzing CH WAIT 904, designers can assess channel utilization efficiency and optimize hardware resource allocation to minimize idle periods and improve throughput.

Collectively, these derived metrics enable robust profiling and optimization of data movement operations, facilitating targeted improvements in hardware and software performance.

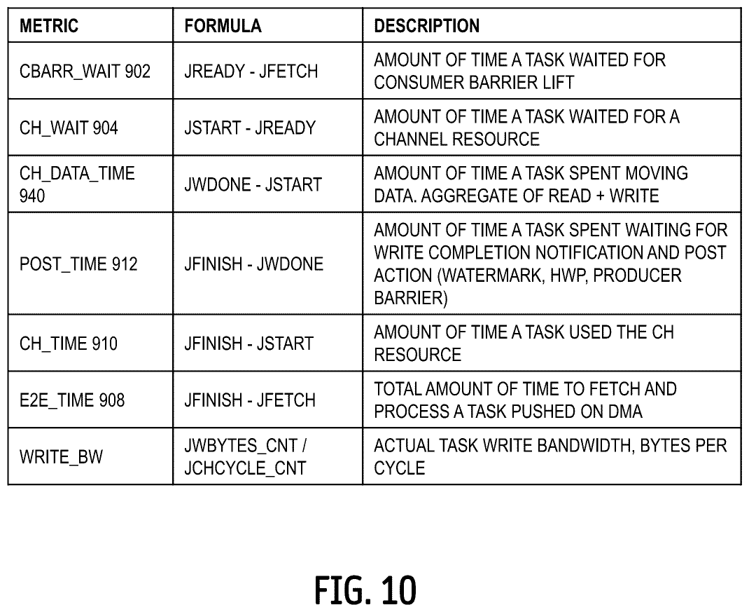

FIG. 10 depicts a table illustrating metrics which can be calculated based on the profiling data in a log data entry, according to some embodiments of the disclosure. The metrics in the table can be derived from profiling information stored in a log entry/record (e.g., specific timestamp or counter fields) using the formula shown.

CBARR_WAIT 902 is computed as the difference between the time when the task descriptor is fetched (JFETCH) and the time when the task is ready (JREADY), representing the amount of time a task waited for a consumer barrier to be lifted.

CH_WAIT 904 is computed as the difference between the time the task became ready (JREADY) and the time it was dispatched to the channel (JSTART), quantifying the time spent waiting for channel resources.

CH_DATA_TIME 940 is calculated as the difference between the time between the start of data movement (JSTART) and the completion of data writes (JWDONE), reflecting the aggregate duration of read and write operations.

POST_TIME 912 is the difference between the write completion time (JWDONE) and the task completion time (JFINISH) and indicating the time spent waiting for write completion notification and post-processing actions, such as watermarking or hardware profiling.

CH_TIME 910 is the time the task used the channel resource, calculated as the difference between the start of data movement where the task is dispatched to the channel (JSTART) and the task completion time (JFINISH).

E2E_TIME 908 is the total time to fetch and process a task, calculated as the difference between the time when the task descriptor is fetched (JFETCH) and the task completion time (JFINISH)

WRITE_BW is the task write bandwidth, which can be computed by dividing the total number of bytes written (JTWBYTES_CNT) by the number of clock cycles taken to complete the writes (JCHCYCLE_CNT), yielding bytes per cycle, or calculating a ratio between total number of bytes written (JTWBYTES_CNT) and the number of clock cycles taken to complete the writes (JCHCYCLE_CNT).

These metrics enable comprehensive analysis and optimization of hardware data movement operations. In some embodiments, one or more metrics seen in FIG. 10 may be derived by HWP circuitry. In some embodiments, one or more metrics seen in FIG. 10 may be derived by profiling software having access to the log data, as part of software post-processing.

### Integration of Hardware Profiling Circuitry in a Data Movement Engine

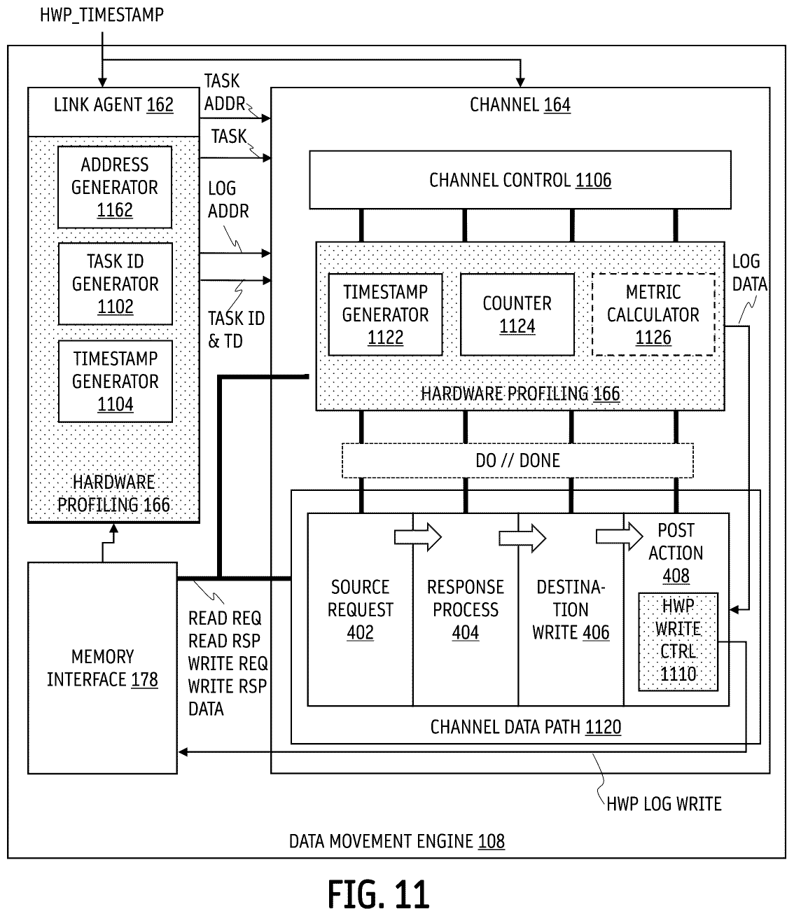

FIG. 11 illustrates data movement engine 108 having hardware profiling 166, according to some embodiments of the disclosure. Data movement engine 108 includes one or more instances of link agent 162 one or more instances of channel 164, and memory interface 178. Data movement engine 108 can execute one or more data movement tasks that move data between a memory of a processor circuit and a further memory. The processor circuit can perform data operations for one or more contexts (e.g., DNN operations). For simplicity, one instance of link agent 162 and one instance of channel 164 is shown. Link agent 162 may dispatch a data movement task (TASK) for processing by channel 164. Channel 164 can perform one or more data movement actions for the data movement task.

Hardware profiling 166 (e.g., hardware profiling circuitry) is integrated with link agent 162 and channel 164. HWP write control 1110, which is part of hardware profiling 166, can be integrated with the block responsible for performing post action 408 in channel data path circuitry 1120. Channel 164 can include channel control logic 1106 and channel data path circuitry 1120.

Channel control logic 1106 manages the orchestration of data movement actions being performed or executed within channel data path circuitry 1120, ensuring that each processing action occurs in the correct sequence. Channel control logic 1106 can coordinate the initiation, execution, and completion of actions by keeping track of control signals such as DO, and DONE sent between channel control logic 1106 and pipelined blocks in channel data path circuitry 1120. Channel data path circuitry 1120 includes pipelined blocks to carry out the four actions: source request action 402, response process action 404, destination write action 406 and post action 408. Execution of the respective actions are managed by channel control logic 1106 issuing a DO control signal to a specific block and waiting for DONE control signal from the specific block before issuing a further DO control signal to a subsequent block.

Hardware profiling 166 integrated with link agent 162 can include address generator 1162. Address generator 1162 can determine a memory address for a data movement task of the one or more data movement tasks. The data movement task is associated with a context of the one or more contexts. Address generator 1162 can allocate a memory address for storing log data for the data movement task according to the buffer allocation scheme illustrated in FIG. 5 and FIG. 6 to store a log entry illustrated in FIG. 6. The memory address (LOG ADDR) is passed onto channel 164, such as hardware profiling 166 and HWP write control 1110 integrated with channel 164, so that the memory address can be used to write the log data to memory.

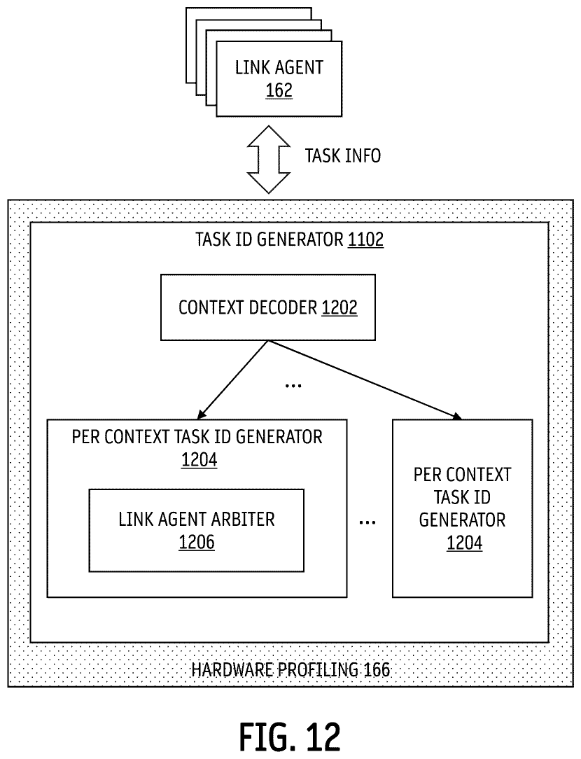

Hardware profiling 166 integrated with link agent 162 may include task ID generator 1102 to determine or optionally generate a task identifier for the data movement task. Task ID determination can be controlled by software (e.g., specified in the task descriptor of the data movement task) or by hardware (e.g., generated by task ID generator 1102 on the fly). Processes relating to task identifier determination are illustrated in greater detail in FIGS. 12-13. The task identifier (TASK ID) is passed onto channel 164, such as hardware profiling 166, to be recorded in a data structure in hardware profiling 166.

Hardware profiling 166 integrated with link agent 162 may include timestamp generator 1104 to record timestamps such as JFETCH 702 and JREADY 704 as illustrated in FIG. 7. The timestamps (TD) are passed onto channel 164, such as hardware profiling 166, to be recorded in a data structure in hardware profiling 166.

Hardware profiling 166 integrated with channel 164 can include timestamp generator 1122 to record timestamps such as JSTART 764, JWDONE 706, and JFINISH 710 as illustrated in FIG. 7.

In some embodiments, hardware profiling 166 integrated with channel 164 may optionally include logic to compute one or more derived metrics, such as one or more metrics illustrated in FIGS. 9-10. The one or more derived metrics may be integrated into the log entry in addition to the raw data or in place of at least some of the raw data.

Hardware profiling 166 integrated with channel 164 can include counter 1124. Counter 1124 may include one or more counters, such as counter to accumulate one or more of: one or more stall counts, a byte count, and one or more cycle counts. Examples of counts, as seen in FIG. 8, can include JWSTALL_CNT and JRSTALL_CNT to track write and read stall events respectively, JCHCYCLE_CNT to record the number of clock cycles for write completion, and JTWBYTES_CNT to log the total number of bytes written.

Hardware profiling 166 has visibility on a system-wide hardware profiling timestamp bus (HWP_TIMESTAMP) that carries a reference timestamp value to be used to sample events. This timestamp bus can be used to sample link agent 162 events and/or channel 164 events. The HWP_TIMESTAMP signal on the bus is a hardware-generated timing reference used by hardware profiling 166 to accurately record the timing of key events during the execution of a data movement task. Specifically, the timestamp bus provides a globally synchronized timestamp value that is sampled whenever a signal indicates that an event has occurred in link agent 162 and/or channel 164, such as control signals (such as DO and DONE) are asserted at various stages of channel data path circuitry 1120 (e.g., source request action 402, response process action 404, destination write action 406, and post action 408). By capturing the HWP_TIMESTAMP on the timestamp bus at these moments, the profiling circuitry can precisely log when each processing action occurs, enabling detailed analysis of task latency, throughput, and performance bottlenecks. This timestamp bus can ensure that reliable profiling data can be generated consistently across link agent 162 and channel 164 to support derived metrics such as end-to-end task duration, channel wait times, and bandwidth calculations. In summary, the HWP_TIMESTAMP bus ensures that all recorded profiling events are temporally aligned and traceable within the hardware accelerator system.

Hardware profiling 166 integrated with link agent 162 and/or channel 164 can record log data associated with the data movement task (e.g., as illustrated in FIGS. 6-8) based on one or more signals in the data movement engine. The one or more signals can indicate one or more events occurring in link agent 162 and/or channel 164. Specifically, the hardware profiling 166 monitors and sniffs signals including, at least one or more of, but not limited to:
Task control signals such as DO and DONE between channel data path circuitry 1120 and channel control logic 1106, which indicate the initiation and completion of processing actions at individual stages of channel data path circuitry 1120, including source request action 402, response process action 404, destination write action 406, and post action 408.
Read request (READ REQ) and read response (READ RSP) signals between channel data path circuitry 1120 and memory interface 178, which are used to record one or more of timestamps and stall counts associated with memory read operations.
Write request (WRITE REQ) and write response (WRITE RSP) signals between channel data path circuitry 1120 and memory interface 178, which are used to record one or more of timestamps and stall counts, associated with memory write operations.
Data signals (DATA) having data being moved by channel data path circuitry 1120, such as data signals representing data being moved out of an intermediate buffer in the block responsible for response process action 404 to a destination memory location by the block responsible for destination write action 406. Data signals can be monitored to record the amount of data moved and to calculate a byte count for the data movement task.

Hardware profiling 166 can store the log data (e.g., timestamps, stall counts, byte count, etc.) in a record or scoreboard for the data movement task. When post action 408 is completed or performed in channel data path circuitry 1120, a DONE signal for post action 408 may trigger hardware profiling 166 to drain the log data from the record and pass the log data to HWP write control 1110 to write the log data at the memory address (LOG ADDR) determined by address generator 1162, via HWP LOG WRITE.

This integration of hardware profiling 166 within data movement engine 108 enables autonomous, context-aware, and fine-grained profiling of data movement tasks. By sniffing and monitoring specific signals (e.g., control signals, request signals (including response signals to the request signals), and data signals) in data movement engine 108, hardware profiling 166 supports scalable parallel profiling, robust traceability, and efficient log data management.

### Hardware Generation of a Task Identifier for a Data Movement Task

FIG. 12 illustrates generating a task identifier for a data movement task, according to some embodiments of the disclosure. Hardware profiling 166 can include task ID generator 1102. Task ID generator 1102 may be utilized to generate a task identifier for a data movement task if hardware generation mode (e.g., where hardware profiling 166 assigns a task identifier instead of using a task identifier provided in the task descriptor) is enabled. Task ID generator 1102 may serve all the instance(s) of link agent 162.

Task ID generator 1102 can receive task information (TASK INFO) for a data movement task from one or more instances of link agent 162.

Task ID generator 1102 can include context decoder 1202. Context decoder 1202 can determine the task identifier by decoding the data movement task, e.g., the task information, to extract the context. Context decoder 1202 can determine a context identifier corresponding to the context.

Task ID generator 1102 can include one or more instances of per-context task ID generator 1204. Task identifiers are to be generated separately and independently for different contexts, thus per-context task ID generator 1204 can be provided for each context. Context decoder 1202 can route a request to per-context task ID generator 1204 that corresponds to the determined context identifier corresponding to the context.

Per-context task ID generator 1204 can generate the task identifier using a monotonic counter corresponding to the context. Having a respective monotonic counter ensures that each context maintains a unique sequence of task IDs, supporting robust traceability and isolation of profiling data.

To efficiently handle multiple simultaneous requests for task identifiers for different data movement tasks of the same context, in some embodiments, per-context task ID generator 1204 can include link agent arbiter 1206. Link agent arbiter 1206 can implement a round-robin arbitration scheme (or random sampling arbitration scheme) to arbitrate between a plurality of requests to generate task identifiers for a plurality of data movement tasks of the same context. The arbitration scheme can guarantee fair and orderly assignment of task identifiers, even under high concurrency, and prevents contention or duplication of identifiers.

### Generating a Memory Address for Storing the Log Data for a Data Movement Task

FIG. 13 illustrates generating a memory address for storing the log data for a data movement task and determining a task identifier for the data movement task, according to some embodiments of the disclosure. The data movement task is associated with a context.

Hardware profiling 166 can include address generator 1162 to generate or determine the memory address. Hardware profiling 166 can include task ID generator 1102 to determine the task identifier or receive the task identifier from link agent 162 (e.g., included in the task descriptor for the data movement task).

Address generator 1162 can determine the memory address by determining a context identifier associated with the context, determining a base address associated with the context based on the context identifier, and determining the memory address based on the base address and the task identifier, and further based on the size of the log data.

Address generator 1162 can include base address per context 1302, which stores one or more base addresses, each associated with a respective context identified by a corresponding context identifier. Selector 1304 can select a base address corresponding to a context identifier from base address per context 1302 and output the context-specific base address to log address generator 1330. Phrased differently, selector 1304 can determine a context-specific base address from base address per context 1302 based on the context identifier associated with the data movement task.

The task identifier may be preassigned by the context (e.g., supplied by link agent 162 in the task descriptor as SW TASK ID), or may be generated by task ID generator 1102 (HW TASK ID). Task ID generator 1102, as discussed with FIG. 12, can generate the task identifier (HW TASK ID) by decoding the data movement task to extract the context and generating the task identifier using a monotonic counter corresponding to the context.

Selector 1310 may receive the SW TASK ID and the HW TASK ID. Based on a task ID enable signal (TASK ID EN), selector 1310 may select either the preassigned task identifier provided by software (SW TASK ID) or the hardware-generated task identifier (HW TASK ID), depending on the state of the task ID enable or select signal. Selector 1310 may determine the task identifier, e.g., based on the task ID enable or select signal, and output the determined or selected task identifier to log address generator 1330. For example, if TASK ID EN==1, SW TASK ID may be selected to apply a software generated task identifier. If TASK ID EN==0, HW TASK ID may be selected to apply a hardware-generated task identifier.

The selected/determined task identifier and the context-specific base address are provided to log address generator 1330. Log address generator 1330 can determine the memory address (LOG ADDR) for storing the log data based on the context-specific base address and the selected task identifier. In at least some embodiments, log address generator 1330 further determines the memory address based on the size of the log data, such that the memory address is computed as the sum of the base address and the product of the task identifier and the log record size.

Accordingly, hardware profiling 166 provides a flexible and scalable mechanism for determining memory addresses for log data records associated with data movement tasks, accommodating both software-assigned and hardware-generated task identifiers, supporting per-context base addresses, and ensuring conflict-free operation in multi-threaded and parallel processing scenarios.

### Parallel Scoreboards to Maintain Log Data for Multiple Data Movement Tasks

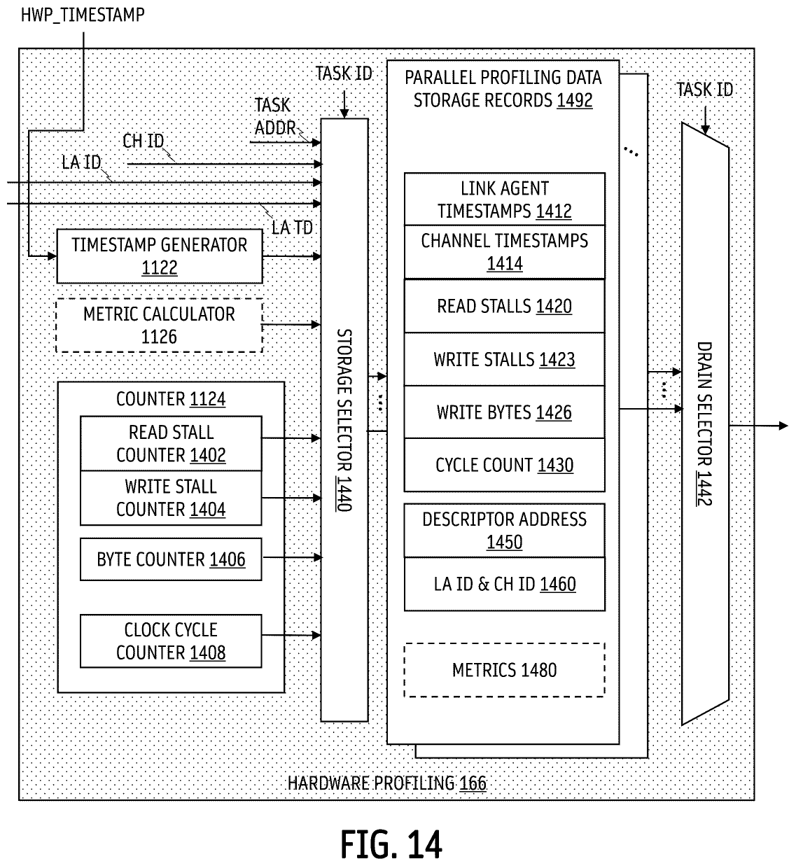

FIG. 14 illustrates recording and draining profiling data for parallel or pipelined data movement tasks, according to some embodiments of the disclosure. As discussed previously, a channel may be processing multiple data movement tasks at a time. Hardware profiling 166 can maintain a plurality of data storage records, e.g., parallel profiling data storage records 1492. A data storage record, e.g., parallel profiling data storage records 1492 can correspond to a specific data movement task having a specific task identifier. Hardware profiling 166 can write a part of the log data for the specific data movement task to the selected data storage record corresponding to the specific data movement task. The number of data storage records is at least a pipeline depth of the channel data path circuitry, supporting concurrent profiling of multiple data movement tasks being processed in the channel.

Based on the post action being performed in the data movement engine, hardware profiling 166 can determine a task identifier associated with the data movement task (the task whose post action was just performed), selects a data storage record from the plurality of data storage records based on the task identifier, and drains the log data from the selected data storage record to the channel data path circuitry for writing to memory.

Hardware profiling 166 comprises timestamp generator 1122, counter 1124, and optionally metric calculator 1126. Timestamp generator 1122 can collect one or more timestamps in the channel for data movement tasks executed within a channel. Counter 1124 can accumulate one or more stall counters, one or more cycle counters, and a byte counter. For example, counter 1124 can include one or more of: read stall counter 1402, write stall counter 1404, byte counter 1406, and clock cycle counter 1408. These counters can monitor appropriate signals in the data movement engine to record respective operational statistics for various data movement tasks. Metric calculator 1126 can optionally calculate metrics based on the profiling information collected by timestamp generator 1122 and/or counter 1124. Timestamp generator 1122, counter 1124, and optionally metric calculator 1126 may collectively sample profiling information for multiple data movement tasks being processed in a channel.

Hardware profiling 166 may receive task descriptor addresses (TASK ADDR) associated with different data movement tasks. Hardware profiling 166 may receive a link agent identifier (LA ID) associated with the link agent that processed a particular data movement task. Hardware profiling 166 may receive a channel identifier (CH ID) associated with the channel that processed the particular data movement task. Hardware profiling 166 may receive one or more timestamps (LA TD) recorded for events associated with a link agent processing the particular movement task.

Hardware profiling 166 can receive one or more parts of profiling information for various data movement tasks being processed in the channel at a given time. To handle the profiling information and ensure that profiling information for different data movement tasks are segregated from each other, hardware profiling 166 may determine a task identifier (TASK ID) associated with the one or more parts of the log data recorded for a particular data movement task, utilize storage selector 1440 to select a data storage record from a plurality of parallel profiling data storage records 1492, and write the one or more parts of the log data recorded for the particular data movement task to the selected data storage record. The number of parallel profiling data storage records 1492 is at least equal to or more than the pipeline depth of the channel data circuitry. Each data storage record can be used to store log data for a corresponding data movement task, ensuring that hardware profiling 166 can track and record profiling information for multiple tasks executing in parallel.

A record of parallel profiling data storage records 1492 can include one or more of: link agent timestamps 1412, channel timestamps 1414, read stalls 1420, write stalls 1423, write bytes 1426, and cycle count 1430. The instance of parallel profiling data storage records 1492 can include descriptor address 1450 to uniquely associate the log data with the corresponding data movement task. The instance of parallel profiling data storage records 1492 can include identifiers for the link agent and/or channel (LA ID & CH ID 1460) to identify the specific pipeline in the data movement engine that processed the particular data movement task. In some embodiments, the include of parallel profiling data storage records 1492 can include metrics 1480 having computed or derived performance metrics for subsequent analysis.

Hardware profiling 166 can, based on the post action of one or more data movement actions being performed in the data movement engine for a particular data movement task, determine a task identifier (TASK ID) associated with the particular data movement task. Drain selector 1442 can select a data storage record from the plurality of parallel profiling data storage records 1492 based on the task identifier and drain the log data from the selected data storage record to the channel data path circuitry. This mechanism ensures that the profiling data for each task is accurately transferred and made available for further processing or reporting.

By maintaining parallel records, hardware profiling 166 supports fine-grained performance analysis even when a high-level of concurrency is present in the channel.

It is envisioned that other mechanisms for recording profiling data separately for different data movement tasks being processed by a channel can be implemented to ensure that the profiling data is tracked and attributed to the appropriate data movement task.

### Example of Profiling Log Entries

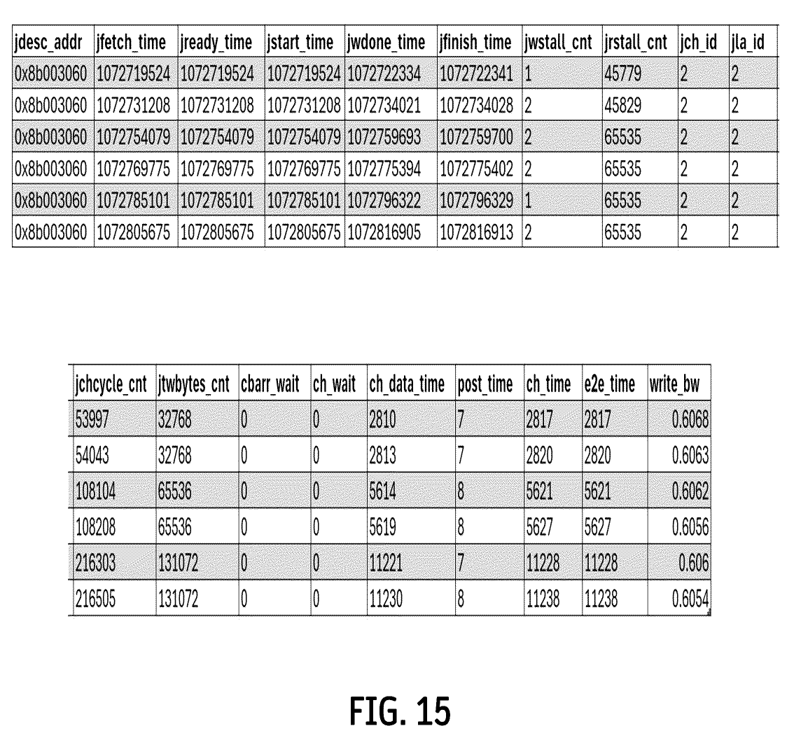

FIG. 15 illustrates profiling data for multiple data movement tasks, according to some embodiments of the disclosure. The table illustrates six exemplary log entries.

### Profiling Data Analysis System

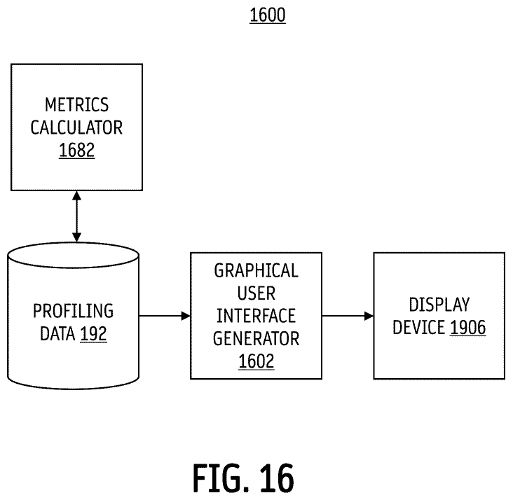

FIG. 16 illustrates system 1600 for analyzing the profiling data, according to some embodiments of the disclosure. System 1600 may include one or more of profiling data 192, metrics calculator 1682, graphical user interface generator 1602, and display device 1906. System 1600 can perform post-processing on profiling data 192 to generate one or more derived metrics and output them to a user, such as a software developer, or a performance optimization system as performance data.

Profiling data 192 can store log entries, as illustrated in FIGS. 6-8, having raw profiling information generated by the HWP circuitry during execution of data movement tasks. Profiling data 192 can include per-task logs having one or more of: timestamps, stall counts, cycle counts, byte counts, task descriptor address, and identifiers.

Metrics calculator 1682 may process the raw profiling data in profiling data 192 and compute a set of derived performance metrics, such as task durations, and bandwidth, as illustrated in FIGS. 9-10. Metrics calculator 1682 may store the derived metrics in profiling data 192.

Raw profiling information and/or computed metrics can be provided to a graphical user interface generator 1602. Graphical user interface generator 1602 can construct a user-facing interface that presents the raw profiling information and/or computed metrics in a visually accessible format. This interface may include timeline views, tabular summaries, and diagnostic plots, allowing a user to filter and examine profiling results by context, data movement task, channel, or link agent. Graphical user interface generator 1602 can organize the information in a manner conducive to visual analysis and decision-making.

The output of the graphical user interface generator 1602 is transmitted to a display device 1906, which renders the graphical user interface for viewing by the user. Display device 1906 may allow software developers to interact with the profiling results, identify performance issues, and facilitate efficient review and tuning of hardware-accelerated applications.

### Methods for Collecting and Analyzing Log Data Associated With Data Movement Tasks

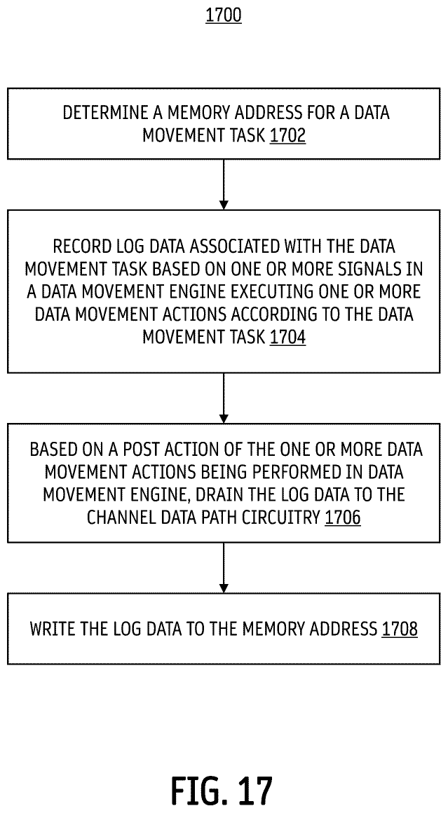

FIG. 17 is a flow diagram illustrating method 1700 for collecting log data associated with data movement tasks, according to some embodiments of the disclosure. Method 1700 may be performed by HWP circuitry and/or data movement engine described herein.

In 1702, the HWP circuitry may determine a memory address for a data movement task. The data movement task is associated with a context of one or more contexts of a multi-threaded processor.

In 1704, the HWP circuitry can record log data associated with the data movement task based on one or more signals in a data movement engine executing one or more actions according to the data movement task. The one or more actions can encompass one or more processing actions of the link agent and/or one or more data movement actions of the channel data path circuitry.

In 1706, based on (or in response to) a post action of the one or more data movement actions being performed or executed in data movement engine (e.g., in the channel data path circuitry), the HWP circuitry can drain the log data to the channel data path circuitry.

In 1708, the data movement engine can write the log data to the memory address by the data movement engine.

In some embodiments, the HWP circuitry determining the memory address by determining a context identifier (CTX_ID) associated with the context associated with the data movement task, determining a base address (DMA_HWP_ADR[CTX_ID]) associated with the context based on the context identifier, determining a task identifier (TASK_ID)associated with the data movement task, and determining the memory address (HWP LOG START ADDRESS) based on the base address, the task identifier, and a size of the log data. The HWP circuitry can perform this calculation: HWP LOG START ADDRESS=DMA_HWP_ADR[CTX_ID]+(TASK_ID*HWP_LOG_SIZE).

In some embodiments, the HWP circuitry determines the task identifier associated with the data movement task by decoding the data movement task to extract the context, and generating the task identifier using a monotonic counter corresponding to the context. In some embodiments, the HWP circuitry determines the task identifier associated with the data movement task by arbitrating in a round-robin manner between a plurality of requests to generate task identifiers for a plurality of data movement tasks associated with the context. An implementation for task identifier generation is depicted and illustrated in FIG. 12.

In some embodiments, the HWP circuitry records the log data by: monitoring the one or more signals in the data movement engine. In some implementations, the one or more signals include one or more control signals controlling performance of the one or more data movement actions (and/or one or more processing actions) for the data movement task (e.g., DO and DONE signals described and illustrated in FIG. 11), and the HWP circuitry records one or more timestamps based on the one or more signals. In some implementations, the one or more signals include one or more request signals between the channel data path circuitry and a memory interface of the data movement engine (e.g., READ REQ, READ RSP, WRITE REQ, and WRITE RSP described and illustrated in FIG. 11), and the HWP circuitry records one or more stall counts based on the one or more signals. In some implementations, the one or more signals include one or more data signals for the data movement task (e.g., DATA described and illustrated in FIG. 11), and the HWP circuitry records a byte count based on the one or more signals. In some implementations, the one or more signals include one or more further control signals controlling performance of a destination write action of the one or more data movement actions for the data movement task (e.g., DO and DONE signals for destination write action 406 described and illustrated in FIG. 11), and the HWP circuitry records a count of cycles based on the one or more signals.

In some embodiments, the HWP circuitry records the log data by determining a task identifier associated with the data movement task, selecting a data storage record from a plurality of data storage records based on the task identifier, and writing the log data to the selected data storage record. A number of the plurality of data storage records is at least a pipeline depth of the channel data circuitry. In some embodiments, the HWP circuitry drains the log data by, based on the post action of the one or more data movement actions being performed in the data movement engine, determining a task identifier associated with the data movement task, selecting a data storage record from a plurality of data storage records based on the task identifier, and draining the log data from the selected data storage record to the channel data path circuitry. An implementation having parallel profiling data storage records is depicted and illustrated in FIG. 14.

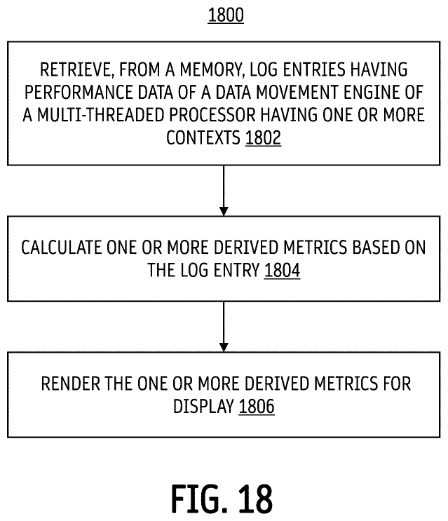

FIG. 18 is a flow diagram illustrating method 1800 for analyzing log data associated with data movement tasks, according to some embodiments of the disclosure. Method 1800 can be performed by one or more parts of system 1600 of FIG. 16.

In 1802, a metrics calculator (e.g., metrics calculator 1682 of FIG. 16) can retrieve, from a memory (e.g., profiling data 192 of FIG. 16), log entries having performance data of a data movement engine of a multi-threaded processor having one or more contexts. A log entry of the log entries corresponds to a data movement task of a context. The log entry includes at least one or more of: one or more timestamps, a cycle count, one or more stall counts, and a byte count.

In 1804, the metrics calculator can calculate one or more metrics based on the log entry. Examples of metrics are illustrated in FIGS. 9-10.

In 1806, the one or more metrics can be rendered for display in a graphical user interface.

In some embodiments, a further log entry of the log entries corresponds to a further data movement task of the context.

In some embodiments, a yet further log entry of the log entries corresponds to a yet further data movement task of a further context of the one or more contexts.

In some embodiments, the metrics calculator calculates a latency interval or duration between a timestamp and a further timestamp of the one or more timestamps. In some implementations, the latency interval corresponds to CBARR_WAIT of FIGS. 9-10, where the timestamp corresponds to fetching a task descriptor of the data movement task (JFETCH) and the further timestamp corresponding to the data movement task becoming ready for execution (JREADY). In some implementations, the latency interval corresponds to CH_WAIT of FIGS. 9-10, where the timestamp corresponds to the data movement task becoming ready for execution (JREADY) and the further timestamp corresponds to a channel data path resource being allocated to execute the data movement task (JSTART). In some implementations, the latency interval corresponds to CH_DATA_TIME of FIGS. 9-10, where the timestamp corresponds to a start time of the data movement task execution (JSTART), and the further timestamp corresponds to a destination write action completion (JWDONE). In some implementations, the latency interval corresponds to POST_TIME of FIGS. 9-10, where the timestamp corresponds to a destination write action completion (JWDONE), and the further timestamp corresponds to a post action completion (JFINISH). In some implementations, the latency interval corresponds to CH_TIME of FIGS. 9-10, where the timestamp corresponds to a start time of the data movement task execution (JSTART), and the further timestamp corresponds to a finish time of the data movement task execution (JFINISH). In some implementations, the latency interval corresponds to E2E_TIME of FIGS. 9-10, where the timestamp corresponds to fetching a task descriptor of the data movement task (JFETCH), and the further timestamp corresponding to a finish time of the data movement task execution (JFINISH).

In some implementations, the metrics calculator calculates a task write bandwidth (e.g., WRITE_BW of FIG. 10) based on a ratio of the byte count (JWBYTES_CNT) and the cycle count (JCHCYCLE_CNT).

### Exemplary Computing Device

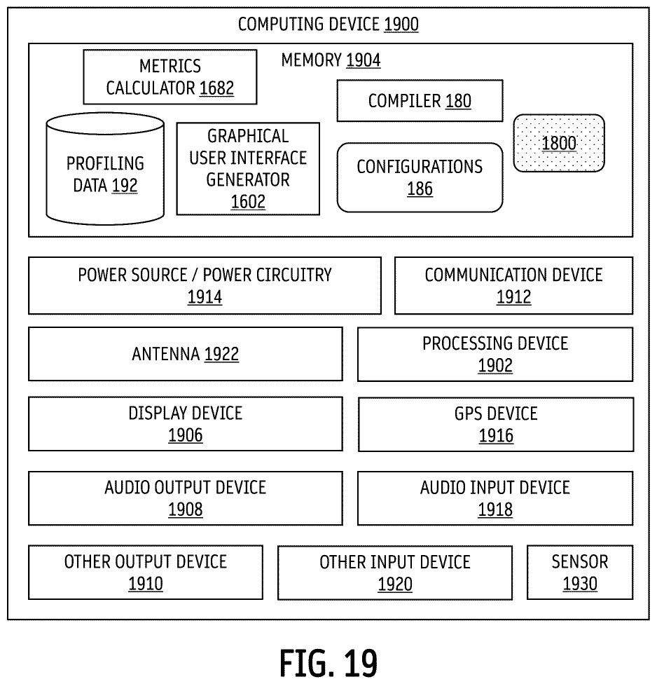

FIG. 19 is a block diagram of an apparatus or a system, e.g., an exemplary computing device 1900, according to some embodiments of the disclosure. One or more computing devices 1900 may be used to implement the functionalities described with the FIGS. and herein. A number of components illustrated in FIG. 19 can be included in the computing device 1900, but any one or more of these components may be omitted or duplicated, as suitable for the application. In some embodiments, some or all of the components included in the computing device 1900 may be attached to one or more motherboards. In some embodiments, some or all of these components are fabricated onto a single SoC die. Additionally, in various embodiments, the computing device 1900 may not include one or more of the components illustrated in FIG. 19, and the computing device 1900 may include interface circuitry for coupling to the one or more components. For example, the computing device 1900 may not include a display device 1906, and may include display device interface circuitry (e.g., a connector and driver circuitry) to which a display device 1906 may be coupled. In another set of examples, the computing device 1900 may not include an audio input device 1918 or an audio output device 1908 and may include audio input or output device interface circuitry (e.g., connectors and supporting circuitry) to which an audio input device 1918 or audio output device 1908 may be coupled.

Computing device 1900 may include a processing device 1902 (e.g., one or more processing devices, one or more of the same types of processing device, one or more of different types of processing device). Processing device 1902 may include electronic circuitry that processes electronic data from data storage elements (e.g., registers, memory, resistors, capacitors, quantum bit cells) to transform that electronic data into other electronic data that may be stored in registers and/or memory. Examples of processing device 1902 may include a CPU, a GPU, a quantum processor, a machine learning processor, an AI processor, a neural network processor, an AI accelerator, an ASIC, an analog signal processor, an analog computer, a microprocessor, a digital signal processor, an FPGA a tensor processing unit (TPU), a neural network hardware accelerator, an SoC (e.g., SoC 170 as illustrated in FIG. 1), a DNN accelerator (e.g., DNN accelerator 120 as illustrated in FIG. 1), an NPU, a DNN acceleration circuit (e.g., DNN acceleration circuit 102 as illustrated in FIG. 1), etc.

Computing device 1900 may include a memory 1904, which may itself include one or more memory devices such as volatile memory (e.g., DRAM), nonvolatile memory (e.g., read-only memory (ROM)), high bandwidth memory (HBM), flash memory, solid state memory, and/or a hard drive. Memory 1904 includes one or more non-transitory computer-readable storage media. In some embodiments, memory 1904 may include memory that shares a die with the processing device 1902.

In some embodiments, memory 1904 includes one or more non-transitory computer-readable media storing instructions executable to perform operations described with the FIGS. and herein. Exemplary parts, e.g., compiler 180, that may be encoded as instructions and stored in memory 1904 are depicted. Memory 1904 may store instructions that encode one or more exemplary parts, such as compiler 180, metrics calculator 1682, and graphical user interface generator 1602. The instructions stored in the one or more non-transitory computer-readable media may be executed by processing device 1902. Memory 1904 may store instructions that cause processing device 1902 to perform one or more methods described and illustrated herein, such as operations to be performed by compiler 180, operations to be performed by metrics calculator 1682, operations to be performed by graphical user interface generator 1602, and operations of method 1800.

In some embodiments, memory 1904 may store data, e.g., data structures, binary data, bits, metadata, files, blobs, etc., as described with the FIGS. and herein. In some embodiments, memory 1904 may store low-level machine-readable instructions, such as configurations 186. In some embodiments, memory 1904 may store at least one or more of weights and activations for a neural network. In some embodiments, memory 1904 may include a memory system as described and illustrated in FIG. 1. In some embodiments, memory 1904 may carry out address translation functions to support a data movement engine for the memory system. In some embodiments, memory 1904 may store profiling data 192.

In some embodiments, memory 1904 may store one or more DNNs (and or parts thereof). Memory 1904 may store training data for training (trained) a DNN. Memory 1904 may store instructions that perform operations associated with training a DNN. Memory 1904 may store input data, output data, intermediate outputs, intermediate inputs of one or more DNNs. Memory 1904 may store one or more parameters used by the one or more DNNs. Memory 1904 may store weights and/or activations of a DNN. Memory 1904 may store information that encodes how nodes of the one or more DNNs are connected with each other. Memory 1904 may store instructions to perform one or more operations of the one or more DNNs. Memory 1904 may store a model definition that specifies one or more operations of a DNN. Memory 1904 may store instructions, such as configuration descriptors, that are generated by a compiler based on the model definition.

In some embodiments, computing device 1900 may include a communication device 1912 (e.g., one or more communication devices). For example, the communication device 1912 may be configured for managing wired and/or wireless communications for the transfer of data to and from the computing device 1900. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not. The communication device 1912 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. Communication device 1912 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication device 1912 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). Communication device 1912 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. Communication device 1912 may operate in accordance with other wireless protocols in other embodiments. The computing device 1900 may include an antenna 1922 to facilitate wireless communications and/or to receive other wireless communications (such as radio frequency transmissions). Computing device 1900 may include receiver circuits and/or transmitter circuits. In some embodiments, Communication device 1912 may manage wired communications, such as electrical, optical, or any other suitable communication protocols (e.g., the Ethernet). As noted above, the communication device 1912 may include multiple communication chips. For instance, a first communication device 1912 may be dedicated to shorter-range wireless communications such as Wi-Fi or Bluetooth, and a second communication device 1912 may be dedicated to longer-range wireless communications such as global positioning system (GPS), EDGE, GPRS, CDMA, WiMAX, LTE, EV-DO, or others. In some embodiments, a first communication device 1912 may be dedicated to wireless communications, and a second communication device 1912 may be dedicated to wired communications.

Computing device 1900 may include power source/power circuitry 1914. The power source/power circuitry 1914 may include one or more energy storage devices (e.g., batteries or capacitors) and/or circuitry for coupling components of the computing device 1900 to an energy source separate from the computing device 1900 (e.g., DC power, AC power, etc.).

Computing device 1900 may include a display device 1906 (or corresponding interface circuitry, as discussed above). The display device 1906 may include any visual indicators, such as a heads-up display, a computer monitor, a projector, a touchscreen display, a liquid crystal display (LCD), a light-emitting diode display, or a flat panel display, for example.

Computing device 1900 may include an audio output device 1908 (or corresponding interface circuitry, as discussed above). The audio output device 1908 may include any device that generates an audible indicator, such as speakers, headsets, or earbuds, for example.

Computing device 1900 may include an audio input device 1918 (or corresponding interface circuitry, as discussed above). The audio input device 1918 may include any device that generates a signal representative of a sound, such as microphones, microphone arrays, or digital instruments (e.g., instruments having a musical instrument digital interface (MIDI) output).

Computing device 1900 may include a GPS device 1916 (or corresponding interface circuitry, as discussed above). The GPS device 1916 may be in communication with a satellite-based system and may receive a location of the computing device 1900, as known in the art.

Computing device 1900 may include a sensor 1930 (or one or more sensors). Computing device 1900 may include corresponding interface circuitry, as discussed above). Sensor 1930 may sense physical phenomenon and translate the physical phenomenon into electrical signals that can be processed by, e.g., processing device 1902. Examples of sensor 1930 may include: capacitive sensor, inductive sensor, resistive sensor, electromagnetic field sensor, light sensor, camera, imager, microphone, pressure sensor, temperature sensor, vibrational sensor, accelerometer, gyroscope, strain sensor, moisture sensor, humidity sensor, distance sensor, range sensor, time-of-flight sensor, pH sensor, particle sensor, air quality sensor, chemical sensor, gas sensor, biosensor, ultrasound sensor, a scanner, etc.

Computing device 1900 may include another output device 1910 (or corresponding interface circuitry, as discussed above). Examples of the other output device 1910 may include an audio codec, a video codec, a printer, a wired or wireless transmitter for providing information to other devices, haptic output device, gas output device, vibrational output device, lighting output device, home automation controller, or an additional storage device.

Computing device 1900 may include another input device 1920 (or corresponding interface circuitry, as discussed above). Examples of the other input device 1920 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

Computing device 1900 may have any desired form factor, such as a handheld or mobile computer system (e.g., a cell phone, a smart phone, a mobile internet device, a music player, a tablet computer, a laptop computer, a netbook computer, a personal digital assistant (PDA), a personal computer, a remote control, wearable device, headgear, eyewear, footwear, electronic clothing, etc.), a desktop computer system, a server or other networked computing component, a printer, a scanner, a monitor, a set-top box, an entertainment control unit, a vehicle control unit, a digital camera, a digital video recorder, an Internet-of-Things device, or a wearable computer system. In some embodiments, the computing device 1900 may be any other electronic device that processes data.

### Select Examples

Example 1 provides an apparatus, including a processor circuit; a memory of the processor circuit; a further memory; and a data movement engine to execute one or more data movement tasks that move data between the memory of the processor circuit and the further memory, the data movement engine including hardware profiling circuitry and channel data path circuitry; where the hardware profiling circuitry is to: determine a memory address for a data movement task of the one or more data movement tasks, the data movement task being for a context of one or more contexts of operations performed by the processor circuit; and record log data associated with the data movement task based on one or more signals in the data movement engine; and where the channel data path circuitry is to: perform one or more data movement actions for the data movement task; and based on a post action of the one or more data movement actions being performed in the data movement engine, write the log data at the memory address.

Example 2 provides the apparatus of example 1, where the hardware profiling circuitry determines the memory address by: determining a base address for the context based on a context identifier identifying the context associated with the data movement task; determining a task identifier associated with the data movement task; and determining the memory address based on the base address and the task identifier.

Example 3 provides the apparatus of example 2, where the hardware profiling circuitry determines the task identifier associated with the data movement task by: decoding the data movement task to extract the context; and generating the task identifier using a monotonic counter corresponding to the context.

Example 4 provides the apparatus of example 3, where the monotonic counter includes a round-robin arbiter to arbitrate among a plurality of requests to generate task identifiers for a plurality of data movement tasks.

Example 5 provides the apparatus of example 1, where the hardware profiling circuitry determines the memory address by: determining a base address for the context based on a context identifier identifying the context associated with the data movement task; obtaining a task identifier associated with the data movement task, where the task identifier is preassigned by the context; and determining the memory address based on the base address and the task identifier.

Example 6 provides the apparatus of any one of examples 2-5, where the hardware profiling circuitry determines the memory address further based on a size of the log data.

Example 7 provides the apparatus of any one of examples 1-6, where the hardware profiling circuitry records the log data by: recording one or more timestamps associated with one or more processing actions of the data movement task that are performed by the data movement engine before the one or more data movement actions for the data movement task are performed by the channel data path circuitry.

Example 8 provides the apparatus of any one of examples 1-7, where the hardware profiling circuitry records the log data by: monitoring the one or more signals in the channel data path circuitry, where the one or more signals include one or more control signals controlling performance of the one or more data movement actions for the data movement task; and recording one or more further timestamps based on the one or more signals.

Example 9 provides the apparatus of any one of examples 1-8, where the hardware profiling circuitry records the log data by: monitoring the one or more signals in the channel data path circuitry, where the one or more signals include one or more request signals between the channel data path circuitry and a memory interface of the data movement engine; and recording one or more stall counts based on the one or more signals.

Example 10 provides the apparatus of any one of examples 1-9, where the hardware profiling circuitry records the log data by: monitoring the one or more signals in the channel data path circuitry, where the one or more signals include one or more data signals for the data movement task; and recording a byte count based on the one or more signals.

Example 11 provides the apparatus of any one of examples 1-10, where the hardware profiling circuitry records the log data by: monitoring the one or more signals in the channel data path circuitry, where the one or more signals include one or more further control signals controlling performance of a destination write action of the one or more data movement actions for the data movement task; and recording a count of cycles based on the one or more signals.

Example 12 provides the apparatus of any one of examples 1-10, where the hardware profiling circuitry records the log data by: determining a task identifier associated with a part of the log data; selecting a data storage record from a plurality of data storage records based on the task identifier; and writing a part of the log data to the selected data storage record.

Example 13 provides the apparatus of example 12, where a number of the plurality of data storage records is at least a pipeline depth of the channel data path circuitry.

Example 14 provides the apparatus of any one of examples 1-13, where the hardware profiling circuitry is further to: based on the post action of the one or more data movement actions being performed in the data movement engine, determine a task identifier associated with the data movement task; select a data storage record from a plurality of data storage records based on the task identifier; and drain the log data from the selected data storage record to the channel data path circuitry.

Example 15 provides a data movement engine for a multi-threaded processor, including a channel data path circuitry to perform one or more data movement actions for a data movement task of one or more data movement tasks, ; and hardware profiling circuitry to: determine a memory address for the data movement task, the data movement task being for a context of one or more contexts of the multi-threaded processor; record log data associated with the data movement task based on one or more signals in the data movement engine; and based on a post action of the one or more data movement actions being performed in the channel data path circuitry, drain the log data to the channel data path circuitry; where the log data is written to the memory address by the channel data path circuitry.

Example 16 provides the data movement engine of example 15, where the hardware profiling circuitry determines the memory address by: determining a base address for the context based on a context identifier identifying the context associated with the data movement task; determining a task identifier associated with the data movement task; and determining the memory address based on the base address, the task identifier, and a size of the log data.

Example 17 provides the data movement engine of example 16, where the hardware profiling circuitry determines the task identifier associated with the data movement task by: decoding the data movement task to extract the context; and generating the task identifier using a monotonic counter corresponding to the context.

Example 18 provides the data movement engine of example 17, where the monotonic counter includes a round-robin arbiter to arbitrate among a plurality of requests to generate task identifiers for a plurality of data movement tasks associated with the context.

Example 19 provides the data movement engine of example 15, where the hardware profiling circuitry determines the memory address by: determining a base address for a context based on a context identifier identifying the context associated with the data movement task; obtaining a task identifier associated with the data movement task, the task identifier being preassigned by the context; and determining the memory address based on the base address, the task identifier, and a size of the log data.

Example 20 provides the data movement engine of any one of examples 16-19, further including an agent to perform one or more processing actions of the data movement task before the channel data path circuitry performs the one or more data movement actions ; where the hardware profiling circuitry records the log data by recording one or more timestamps associated with the one or more processing actions of the data movement task.

Example 21 provides the data movement engine of any one of examples 16-20, where the hardware profiling circuitry records the log data by: sniffing the one or more signals in the channel data path circuitry, where the one or more signals include one or more control signals controlling performance of the one or more data movement actions for the data movement task; and recording one or more further timestamps based on the one or more signals.

Example 22 provides the data movement engine of any one of examples 16-21, where the hardware profiling circuitry records the log data by: sniffing the one or more signals in the channel data path circuitry, where the one or more signals include one or more request signals between the channel data path circuitry and a memory interface of the data movement engine; and recording one or more stall counts based on the one or more signals.

Example 23 provides the data movement engine of any one of examples 16-22, where the hardware profiling circuitry records log data by: sniffing the one or more signals in the channel data path circuitry, where the one or more signals include one or more data signals for the data movement task; and recording a byte count based on the one or more signals.

Example 24 provides the data movement engine of any one of examples 16-23, where the hardware profiling circuitry records the log data by: sniffing the one or more signals in the channel data path circuitry, where the one or more signals include one or more further control signals controlling performance of a destination write action of the one or more data movement actions for the data movement task; and recording a count of cycles based on the one or more signals.

Example 25 provides the data movement engine of any one of examples 16-24, where the hardware profiling circuitry records the log data by: determining a task identifier associated with a part of the log data; selecting a data storage record from a plurality of data storage records based on the task identifier, where a number of the plurality of data storage records is at least a pipeline depth of the channel data path circuitry; and writing the part of the log data to the selected data storage record.

Example 26 provides the data movement engine of any one of examples 16-25, where the hardware profiling circuitry drains the log data by: based on the post action of the one or more data movement actions being performed in the data movement engine, determining a task identifier associated with the data movement task; selecting a data storage record from a plurality of data storage records based on the task identifier; and draining the log data from the selected data storage record to the channel data path circuitry.

Example 27 provides a method, including determining a memory address for a data movement task, the data movement task being for a context of one or more contexts of a multi-threaded processor; recording log data associated with the data movement task based on one or more signals in a data movement engine executing one or more actions according to the data movement task; and based on a post action of the one or more actions being performed in the data movement engine, draining the log data to a channel data path circuitry, where the log data is written to the memory address by the data movement engine.

Example 28 provides the method of example 27, where determining the memory address includes determining a base address associated with the context based on a context identifier identifying the context associated with the data movement task; determining a task identifier associated with the data movement task; and determining the memory address based on the base address, the task identifier, and a size of the log data.

Example 29 provides the method of example 28, where determining the task identifier associated with the data movement task includes decoding the data movement task to extract the context; and generating the task identifier using a monotonic counter corresponding to the context.

Example 30 provides the method of example 29, where determining the task identifier associated with the data movement task includes arbitrating in a round-robin manner between a plurality of requests to generate task identifiers for a plurality of data movement tasks associated with the context.

Example 31 provides the method of any one of example 27-30, where recording the log data includes monitoring the one or more signals in the data movement engine, where the one or more signals include one or more control signals controlling performance of the one or more actions for the data movement task; and recording one or more timestamps based on the one or more signals.

Example 32 provides the method of any one of examples 27-31, where recording the log data includes monitoring the one or more signals in the channel data path circuitry, where the one or more signals include one or more request signals between the channel data path circuitry and a memory interface of the data movement engine; and recording one or more stall counts based on the one or more signals.

Example 33 provides the method of any one of examples 27-32, where recording the log data includes monitoring the one or more signals in the channel data path circuitry, where the one or more signals include one or more data signals for the data movement task; and recording a byte count based on the one or more signals.

Example 34 provides the method of any one of examples 27-33, where recording the log data includes monitoring the one or more signals in the channel data path circuitry, where the one or more signals include one or more further control signals controlling performance of a destination write action of the one or more actions for the data movement task; and recording a count of cycles based on the one or more signals.

Example 35 provides the method of any one of examples 27-34, where recording the log data includes determining a task identifier associated with the data movement task; selecting a data storage record from a plurality of data storage records based on the task identifier, where a number of the plurality of data storage records is at least a pipeline depth of the channel data path circuitry; and writing the log data to the selected data storage record.

Example 36 provides the method of any one of examples 27-35, where draining the log data includes based on the post action of the one or more actions being performed in the data movement engine, determining a task identifier associated with the data movement task; selecting a data storage record from a plurality of data storage records based on the task identifier; and draining the log data from the selected data storage record to the channel data path circuitry.

Example 37 provides a method, including retrieving, from a memory, log entries having performance data of a data movement engine of a multi-threaded processor having one or more contexts, where a log entry of the log entries corresponds to a data movement task of a context, and the log entry includes at least one or more of: one or more timestamps, a cycle count, one or more stall counts, and a byte count; calculating one or more metrics based on the log entry; and rendering the one or more metrics for display in a graphical user interface.

Example 38 provides the method of example 37, where a further log entry of the log entries corresponds to a further data movement task of the context.

Example 39 provides the method of example 37 or 38, where a yet further log entry of the log entries corresponds to a yet further data movement task of a further context of the one or more contexts.

Example 40 provides the method of any one of examples 37-39, where calculating the one or more metrics includes calculating a latency interval between a timestamp and a further timestamp of the one or more timestamps.

Example 41 provides the method of example 40, where: the timestamp corresponds to fetching a task descriptor of the data movement task, and the further timestamp corresponding to the data movement task becoming ready for execution.

Example 42 provides the method of example 40, where: the timestamp corresponds to the data movement task becoming ready for execution; and the further timestamp corresponds to a channel data path resource being allocated to execute the data movement task.

Example 43 provides the method of example 40, where: the timestamp corresponds to a start time of an execution of the data movement task; and the further timestamp corresponds to a destination write action completion.

Example 44 provides the method of example 40, where: the timestamp corresponds to a destination write action completion; and the further timestamp corresponds to a post action completion.

Example 45 provides the method of example 40, where: the timestamp corresponds to a start time of an execution of the data movement task; and the further timestamp corresponds to a finish time of the execution of the data movement task.

Example 46 provides the method of example 40, where: the timestamp corresponds to fetching a task descriptor of the data movement task; and the further timestamp corresponding to a finish time of an execution of the data movement task.

Example 47 provides the method of any one of examples 37-46, where calculating the one or more metrics includes calculating a task write bandwidth based on a ratio of the byte count and the cycle count.

Example 48 provides an apparatus including means for performing a method according to any one of examples 27-47.

Example 49 provides a computer program product including instructions which, when executed by a processor, cause the processor to perform a method according to any one of examples 37-47.

Example 50 provides machine-readable storage including machine-readable instructions, when executed, cause a computer to implement a method according to any one of examples 37-47.

Example 51 provides a computer program including instructions which, when the computer program is executed by a processing device, cause the processing device to carry out a method according to any one of examples 37-47.

Example 52 provides a computer-implemented system, including one or more processors, and one or more non-transitory computer-readable media storing instructions that, when executed by the one or more processors, cause the one or more processors to perform a method according to any one of examples 37-47.

### Variations and Other Notes

Although the operations of the example method shown in and described with reference to FIGS. are illustrated as occurring once each and in a particular order, it will be recognized that some operations may be performed in any suitable order and repeated as desired. Furthermore, the operations illustrated in FIGS. may be combined or may include more or fewer details than described.

The various implementations described herein may refer to AI, machine learning, and deep learning. Deep learning may be a subset of machine learning. Machine learning may be a subset of AI. In cases where a deep learning model is mentioned, if suitable for a particular application, a machine learning model may be used instead. In cases where a deep learning model is mentioned, if suitable for a particular application, a digital signal processing system may be used instead.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

For purposes of explanation, specific numbers, materials and configurations are set forth in order to provide a thorough understanding of the illustrative implementations. However, it will be apparent to one skilled in the art that the present disclosure may be practiced without the specific details and/or that the present disclosure may be practiced with only some of the described aspects. In other instances, well known features are omitted or simplified in order not to obscure the illustrative implementations.

Further, references are made to the accompanying drawings that form a part hereof, and in which are shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the disclosed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges. For the purposes of the present disclosure, the phrase “one or more of A, B, and C”, the phrase “at least one of A, B, and C”, or the phrase “at least one or more of A, B, and C” means (A), (B), (C), (A and B), (A and C), (B and C), or (A, B, and C). The term “between,” when used with reference to measurement ranges, is inclusive of the ends of the measurement ranges.

For the purposes of the present disclosure, “A is less than or equal to a first threshold” is equivalent to “A is less than a second threshold” provided that the first threshold and the second thresholds are set in a manner so that both statements result in the same logical outcome for any value of A. For the purposes of the present disclosure, “B is greater than a first threshold” is equivalent to “B is greater than or equal to a second threshold” provided that the first threshold and the second thresholds are set in a manner so that both statements result in the same logical outcome for any value of B.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, or device, that comprises a list of elements is not necessarily limited to only those elements but may include other elements not expressly listed or inherent to such method, process, or device. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description and the accompanying drawings.

1. An apparatus, comprising:
a processor circuit;
a memory of the processor circuit;
a further memory; and
a data movement engine to execute one or more data movement tasks that move data between the memory of the processor circuit and the further memory, the data movement engine comprising hardware profiling circuitry and channel data path circuitry;
wherein the hardware profiling circuitry is to:
determine a memory address for a data movement task of the one or more data movement tasks, the data movement task being for a context of one or more contexts of operations performed by the processor circuit; and
record log data associated with the data movement task based on one or more signals in the data movement engine; and
wherein the channel data path circuitry is to:
perform one or more data movement actions for the data movement task; and
based on a post action of the one or more data movement actions being performed in the data movement engine, write the log data at the memory address.

2. The apparatus of claim 1, wherein the hardware profiling circuitry determines the memory address by:
determining a base address for the context based on a context identifier identifying the context associated with the data movement task;
determining a task identifier associated with the data movement task; and
determining the memory address based on the base address and the task identifier.

3. The apparatus of claim 2, wherein the hardware profiling circuitry determines the task identifier associated with the data movement task by:
decoding the data movement task to extract the context; and
generating the task identifier using a monotonic counter corresponding to the context.

4. The apparatus of claim 3, wherein the monotonic counter includes a round-robin arbiter to arbitrate among a plurality of requests to generate task identifiers for a plurality of data movement tasks.

5. The apparatus of claim 1, wherein the hardware profiling circuitry determines the memory address by:
determining a base address for the context based on a context identifier identifying the context associated with the data movement task;
obtaining a task identifier associated with the data movement task, wherein the task identifier is preassigned by the context; and
determining the memory address based on the base address and the task identifier.

6. The apparatus of claim 2, wherein the hardware profiling circuitry determines the memory address further based on a size of the log data.

7. The apparatus of claim 1, wherein the hardware profiling circuitry records the log data by:
recording one or more timestamps associated with one or more processing actions of the data movement task that are performed by the data movement engine before the one or more data movement actions for the data movement task are performed by the channel data path circuitry.

8. The apparatus of claim 1, wherein the hardware profiling circuitry records the log data by:
monitoring the one or more signals in the channel data path circuitry, wherein the one or more signals include one or more control signals controlling performance of the one or more data movement actions for the data movement task; and
recording one or more further timestamps based on the one or more signals.

9. The apparatus of claim 1, wherein the hardware profiling circuitry records the log data by:
monitoring the one or more signals in the channel data path circuitry, wherein the one or more signals include one or more request signals between the channel data path circuitry and a memory interface of the data movement engine; and
recording one or more stall counts based on the one or more signals.

10. The apparatus of claim 1, wherein the hardware profiling circuitry records the log data by:
monitoring the one or more signals in the channel data path circuitry, wherein the one or more signals include one or more data signals for the data movement task; and
recording a byte count based on the one or more signals.

11. The apparatus of claim 1, wherein the hardware profiling circuitry records the log data by:
monitoring the one or more signals in the channel data path circuitry, wherein the one or more signals include one or more further control signals controlling performance of a destination write action of the one or more data movement actions for the data movement task; and
recording a count of cycles based on the one or more signals.

12. The apparatus of claim 1, wherein the hardware profiling circuitry records the log data by:
determining a task identifier associated with a part of the log data;
selecting a data storage record from a plurality of data storage records based on the task identifier; and
writing a part of the log data to the selected data storage record.

13. The apparatus of claim 12, wherein a number of the plurality of data storage records is at least a pipeline depth of the channel data path circuitry.

14. The apparatus of claim 1, wherein the hardware profiling circuitry is further to:
based on the post action of the one or more data movement actions being performed in the data movement engine, determine a task identifier associated with the data movement task;
select a data storage record from a plurality of data storage records based on the task identifier; and
drain the log data from the selected data storage record to the channel data path circuitry.

15. A data movement engine for a multi-threaded processor, comprising:
a channel data path circuitry to perform one or more data movement actions for a data movement task of one or more data movement tasks,; and
hardware profiling circuitry to:
determine a memory address for the data movement task, the data movement task being for a context of one or more contexts of the multi-threaded processor;
record log data associated with the data movement task based on one or more signals in the data movement engine; and
based on a post action of the one or more data movement actions being performed in the channel data path circuitry, drain the log data to the channel data path circuitry;
wherein the log data is written to the memory address by the channel data path circuitry.

16. The data movement engine of claim 15, wherein the hardware profiling circuitry determines the memory address by:
determining a base address for the context based on a context identifier identifying the context associated with the data movement task;
determining a task identifier associated with the data movement task; and
determining the memory address based on the base address, the task identifier, and a size of the log data.

17. The data movement engine of claim 16, wherein the hardware profiling circuitry determines the task identifier associated with the data movement task by:
decoding the data movement task to extract the context; and
generating the task identifier using a monotonic counter corresponding to the context.

18. The data movement engine of claim 17, wherein the monotonic counter includes a round-robin arbiter to arbitrate among a plurality of requests to generate task identifiers for a plurality of data movement tasks associated with the context.

19. A method, comprising:
determining a memory address for a data movement task, the data movement task being for a context of one or more contexts of a multi-threaded processor;
recording log data associated with the data movement task based on one or more signals in a data movement engine executing one or more actions according to the data movement task; and
based on a post action of the one or more actions being performed in the data movement engine, draining the log data to a channel data path circuitry, wherein the log data is written to the memory address by the data movement engine.

20. The method of claim 19, wherein recording the log data comprises:
monitoring the one or more signals in the data movement engine, wherein the one or more signals include one or more control signals controlling performance of the one or more actions for the data movement task; and
recording one or more timestamps based on the one or more signals.
